(19) United States
(12) Patent Application Publication
(10) Pub. No.: US 2026/0309119 A1
(43) Pub. Date: Oct. 8, 2026

(54) INFRASTRUCTURE-INTEGRATED FLUID TURBINE SYSTEM

(71) Applicant: Zara Ara Price, Marathon, FL (US)

(72) Inventor: Zara Ara Price, Marathon, FL (US)

(21) Appl. No.: 19/708,332

(22) Filed: Jun. 15, 2026

Related U.S. Application Data
(63) Continuation-in-part of application No. 19/231,961, filed on Jun. 9, 2025, now Pat. No. 12,655,826.
(60) Provisional application No. 63/687,907, filed on Aug. 28, 2024.

(51) Int. Cl. F03B 13/26

(52) U.S. Cl. CPC F03B 13/264; F05B 2220/706; F05B 2240/931

(57) ABSTRACT

A sealed cylindrical turbine apparatus generates electricity from tidal currents, river flow, wind, pipe pressure, and vehicle or aircraft airflow when mounted to existing infrastructure without new construction or seabed drilling. Only the blade tube and its blade ring rotate; all other concentrically arranged layers are fixed. Blades on the inner cylindrical face extract kinetic energy from fluid flowing through an annular channel, driving a permanent magnet motor to generate electrical current transmitted through an external inverter to a grid or storage device. In tidal and river deployments the housing mounts around a pre-existing piling or structural member. In the tidal embodiment, bidirectional scroll chambers accelerate and pre-rotate incoming fluid before blade contact; paired flow gate assemblies maintain unidirectional blade rotation through flood and ebb phases and seal both inlets during storm surge. A dedicated thermal management and control layer provides storm detection, icing protection, and inter-unit mesh coordination.

### CROSS-REFERENCE TO RELATED APPLICATION

This application is a continuation-in-part of U.S. application Ser. No. 19/231,961, filed Jun. 9, 2025, which claims the benefit of priority of U.S. Provisional Application No. 63/687,907, filed Aug. 28, 2024, the contents of both of which are incorporated herein by reference in their entirety.

### BACKGROUND OF THE DISCLOSURE

The present disclosure relates to systems and devices for generating energy and, more particularly, to an infrastructure-integrated fluid turbine system for generating electricity from tidal, wind, river, pipe, vehicle, and marine fluid flows.

Power plants have a difficult time maintaining enough supply to meet society's current demand. As society grows, demand will grow, and the problems of a mismatch between supply and demand will grow. Further, these plants require fuel to generate and deliver power to population centers. Natural resources used to sustain populations are destroyed in the process of drilling and mining for fossil fuels. Not only is sustainability an issue, but the carbon emissions generated by each power plant harm the earth's atmosphere.

Most energy resources do not provide sustained, uninterrupted electricity. There is a need for improvements in power generation and delivery systems that harness continuous natural energy sources—including tidal flows, river currents, wind, and the kinetic energy of moving vehicles and vessels—using existing infrastructure without new construction, seabed drilling, or land use.

### SUMMARY OF THE DISCLOSURE

In one aspect, a turbine apparatus for generating electrical energy from a fluid flow is provided, comprising a sealed cylindrical housing having a longitudinal axis and comprising concentrically arranged layers including a rotating blade tube carrying a blade ring with radially inward-extending blades, a motor layer comprising a high-strength permanent magnet rotor and a stator operatively coupled to the blade tube, and a mounting interface configured to secure the housing to a pre-existing support structure without modification of the pre-existing support structure.

In another aspect, an infrastructure-integrated turbine apparatus is provided, comprising a sealed tubular turbine unit having a longitudinal bore axis, a blade assembly comprising a blade ring defining an annular flow channel and carrying radially inward-extending blades configured to rotate the blade ring when fluid flows through the annular flow channel, an electromagnetic generator assembly comprising a permanent magnet array and a stator winding, and a clamping mounting interface configured to attach the unit to a pre-existing structural member without drilling, seabed anchoring, or any other modification of the pre-existing structural member.

In yet another aspect, a method of generating electrical energy from fluid flow is provided, comprising securing a sealed cylindrical turbine housing to a pre-existing infrastructure structure without modification; directing fluid flow through an annular flow channel to drive a rotating blade tube carrying a blade ring with radially inward-extending blades; rotating a permanent magnet array relative to a stationary stator winding to generate electrical current; and transmitting the electrical current through an inverter to an electrical grid or energy storage device.

### BRIEF DESCRIPTION OF THE DRAWINGS

FIG. 1A is a longitudinal cross-sectional view of a tidal turbine unit according to an embodiment of the present disclosure, mounted on a bridge piling, depicting the ebb tide flow state in which tidal current enters from a first direction and drives the blade ring in a first rotational direction.

FIG. 1B is a longitudinal cross-sectional view of the tidal turbine unit of FIG. 1A, depicting the flood tide flow state in which tidal current enters from the opposing direction and the blade ring continues to rotate in the same first rotational direction or in a second, counter-rotational direction.

FIG. 2 is a transverse cross-sectional view of a turbine unit viewed along the bore axis, according to an embodiment of the present disclosure.

FIG. 3A is an end plan view, taken along the bore axis, of a flow gate assembly according to an embodiment of the present disclosure in an open state.

FIG. 3B is an end plan view of the flow gate assembly of FIG. 3A in an intermediate state.

FIG. 3C is an end plan view, taken along the bore axis, of the flow gate assembly of FIG. 3A in a closed state.

FIG. 4A is a longitudinal cross-sectional view of a turbine unit according to an embodiment of the present disclosure, taken along the bore axis, depicting the axial end cap scroll chamber configuration in which spiral volute scroll chambers are disposed as annular end caps at opposing axial ends of the sealed cylindrical housing.

FIG. 4B is a longitudinal cross-sectional view of a turbine unit according to an embodiment of the present invention taken along the bore axis, depicting the side-wall toroidal scroll chamber configuration in which scroll chambers are disposed circumferentially around the side wall of the housing with horizontal side ports oriented to receive tidal current.

FIG. 5 is an end plan view, taken along the bore axis, of a flow path through a spiral volute scroll according to an embodiment of the present disclosure.

FIG. 6 is an end plan view, taken along the bore axis, of a bidirectional passive flux valve assembly according to an embodiment of the present disclosure.

FIG. 7A is an elevation view of a tidal blade strip according to an embodiment of the present disclosure, having a narrow blade width and a sinusoidal free edge with a short tight wave cycle, optimized for weaker tidal current conditions.

FIG. 7B is an elevation view of a tidal blade strip according to another embodiment of the present disclosure, having a blade width approximately twice that of the tidal blade strip of FIG. 7A and a sinusoidal free edge with a longer wave cycle, optimized for stronger tidal current conditions.

FIG. 8A is a schematic view of the interior of a turbine bore depicting the helical blade strip arrangement according to an embodiment of the present disclosure, showing root edges bonded to the inner cylindrical face along a helical path and sinusoidal free edges engaging fluid at multiple axial positions simultaneously.

FIG. 8B is a schematic view of the interior of a turbine bore depicting a conventional straight-blade arrangement for comparison, showing dead zones between adjacent blade strips.

FIG. 9 is a front elevation view of a wind turbine according to an embodiment of the present disclosure.

FIG. 10 is an enlarged sectional detail view of the swivel joint of FIG. 9.

FIG. 11A is an elevation view of a wind turbine blade according to an embodiment of the present disclosure, having a leaf planform profile with overlapping short-wave scallop ridges and a circular root ball, configured for lighter wind conditions.

FIG. 11B is an elevation view of a wind turbine blade according to another embodiment of the present disclosure, having a leaf planform profile with a sinusoidal wave profile of larger amplitude corrugations and a circular root ball, configured for stronger wind conditions.

FIG. 12 is a front elevation view of a hexagonal carbon fiber mesh face grate according to an embodiment of the present disclosure.

FIG. 13 is a side elevation view of a river turbine according to an embodiment of the present disclosure.

FIG. 14 is a side elevation view of a marine hull turbine array according to an embodiment of the present disclosure.

FIG. 15 is a bottom plan view of the marine hull turbine array of FIG. 14, according to an embodiment of the present disclosure.

FIG. 16 is a longitudinal cross-sectional view of a pipe inline turbine according to an embodiment of the present disclosure, taken along the bore axis.

FIG. 17 is a schematic side elevation view of a vehicle turbine according to an embodiment of the present disclosure.

FIG. 18 is a schematic side elevation view of an aircraft nacelle turbine according to an embodiment of the present disclosure.

FIG. 19 is a schematic block diagram of a control module according to an embodiment of the present disclosure.

FIG. 20 is a side elevation view of a pipe inline turbine assembly according to an embodiment of the present disclosure.

FIG. 21 is a schematic front view of a solid-state battery module according to an embodiment of the present disclosure.

FIG. 22 is an enlarged detail view of a variable-pitch blade of the unit of FIG. 2, according to an embodiment of the present disclosure.

FIG. 23 is a sectional elevation view of a saltwater pressure battery module according to an embodiment of the present disclosure.

FIG. 24 is a longitudinal sectional view of a bearing assembly according to an embodiment of the present disclosure.

FIG. 25A is a sectional view of a passive check valve in a closed state according to an embodiment of the present disclosure.

FIG. 25B is a sectional view of the passive check valve of FIG. 25A in an open state.

FIG. 26A is a front elevation view of a HEX Chain blade according to an embodiment of the present disclosure.

FIG. 26B is a sectional view of the HEX Chain blade of FIG. 26A taken through the hexagonal prism cells.

FIG. 26C is a schematic view of the inner cylindrical face of the blade tube laid flat, showing the helical arrangement of HEX Chain blade strips according to an embodiment of the present disclosure.

FIG. 27 is a longitudinal sectional schematic of the electromagnetic machine according to an embodiment of the present disclosure, showing the permanent magnet array carried on the blade cylinder and the stator winding of the motor layer.

### DETAILED DESCRIPTION

The following detailed description is of currently contemplated modes of carrying out embodiments of the present disclosure. The description is not to be taken in a limiting sense but is made merely for the purpose of illustrating the general principles of the invention, since the scope of the invention is best defined by the appended claims.

The turbine system of the present disclosure is designed to provide sustained electricity generation with minimal environmental impact. The system is mountable on existing infrastructure including bridge pilings, power poles, vessel hulls, and pipes without new construction, seabed drilling, or land use. The system has no carbon dioxide footprint in operation and is designed for low-maintenance operation.

Industrial applications include recovering energy from fluid transport systems, water towers, and industrial facilities, while transportation applications utilize compact turbines in airflow pathways to capture airflow during operation. The system is particularly well-suited for environments with continuous natural energy sources such as tidal flows, river currents, and consistent wind near bridges. Potential installation sites include bridges, electrical distribution structures, utility support systems, buildings, automotive airflow systems, waterways, industrial facilities, and pipeline applications.

The turbine system features a modular design that simplifies manufacturing and maintenance while ensuring compatibility across diverse deployment scenarios. Some examples of modular combinations are shown in the table below.

| Function | Example 1 | Example 2 | Example 3 | Example 4 |
|---|---|---|---|---|
| Energy | Turbines in | Turbines in | Water wheel: | |
| extraction | parallel: axis | series: axis | axis | |
| | parallel to | parallel to | perpendicular | |
| | fluid flow | fluid flow | to fluid flow | |
| Energy | Hydraulic | Direct | Air | Water |
| transfer | pump and | electricity | compressor | pump |
| | circuit | generation | | |
| Energy | Accumulator- | Compressed | Elevated | Battery |
| storage | hydraulic | air storage | water tank | array |
| | pressure | tank | | |
| Energy | Hydraulically | Air-driven | Gravity-fed | Direct |
| dissipation | driven | generator | hydroelectric | current |
| | generator | | generator | (DC) |
| | | | | connection |
| | | | | to battery |
| | | | | array |

As used herein, the term “sealed” means hermetically isolated from fluid ingress to all layers inward of the blade tube during normal operation and during the storm-protection closed state, such that no fluid contacts the motor layer, bearing layer, or dedicated control layer. The term “infrastructure” means any pre-existing man-made structure including bridge pilings, piers, power transmission towers, vessel hulls, and fluid conveyance pipes. The term “without modification” means without drilling into, permanently fastening to, welding to, or otherwise altering the structural material or surface of the pre-existing support structure, and is satisfied by a clamping, banding, or friction-fit mounting interface that is removable without leaving permanent alteration to the support structure. The term “fluid-tight end connections” means any connection interface configured to prevent fluid bypass between the sealed cylindrical housing and the existing fluid conveyance pipe, including without limitation flanged connections, threaded connections, compression fittings, and welded joints. The term “pre-existing support structure” and the term “pre-existing structural member” are used interchangeably to mean any infrastructure element existing prior to installation of the turbine apparatus.

### EXAMPLE

In an example, a prototype turbine having a diameter of about 6 inches to about 8 inches may exhibit approximately the following parameters:

| Factor | Model 1 |
|---|---|
| Revolutions per | 10 to 42, not expected to |
| minute (RPM) (N) | exceed 50 |
| Power (P) | At least 3 kW |
| Torque (T) | 666.08 Nm at 32 rpm |
| Electrical Power | 2,202.87 W at 32 rpm |

The prototype in the example above was designed for a small hydro turbine generator fitted in an 8-inch diameter pipe. The prototype integrates all core system components including the housing assembly, blade system, bearing assembly, and electrical generation components into a compact form factor designed for easy installation in standard 8-inch diameter piping. The prototype serves as a validation platform for subsequent scaled implementations.

### REFERRING TO THE FIGURES

### I. Multi-Layer Sealed Cylindrical Construction

### A. Overview

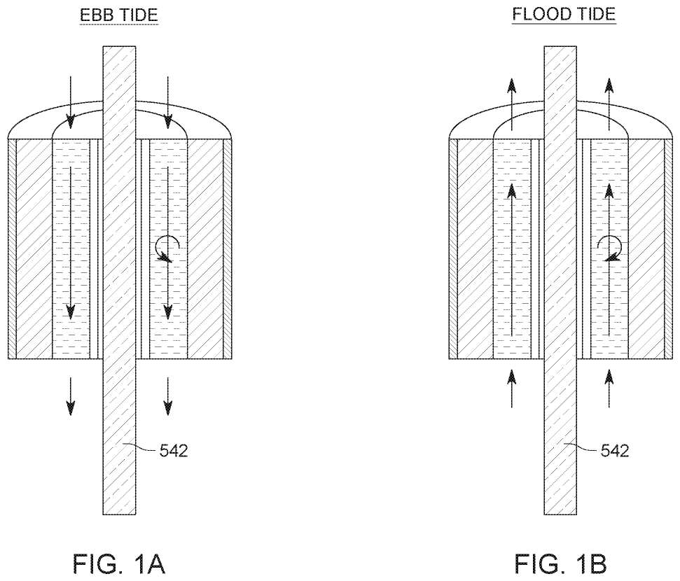

Referring to FIGS. 1A, 1B, 2, 4A, and 4B, the turbine unit comprises a plurality of concentric cylindrical layers arranged radially outward from a central support structure—piling 542 in tidal and river deployments—to an outer housing 124 at the periphery. The concentric layer arrangement provides structural support, vibration isolation, rotational bearing support, electrical generation, thermal management, sensing, and environmental protection within a single sealed assembly. The blade tube 110 is the sole rotating layer during operation. All other layers are fixed relative to the piling 542. No fluid contacts any layer inward of the blade tube 110 during operation.

The turbine unit is configured for installation on existing infrastructure including bridge pilings, power poles, pipe walls, and vessel hulls without requiring drilling, seabed anchoring, or new construction. A clamp mount system secures the unit to the central support structure using external hardware. In tidal and river deployments, the layer architecture is symmetric about the piling 542, with rubber isolation layers on both the inner and outer faces of the assembly. In embodiments where no central support structure passes through the turbine unit, including wind, vehicle, and aircraft embodiments, the inner rubber isolation layers are absent, and the sealed cylindrical housing comprises a single outer sleeve architecture.

### B. Individual Layer Descriptions

### 1. Central Support Structure

The central support structure comprises an existing infrastructure element such as a bridge piling 542, power transmission tower, pipe wall, or vessel hull. The turbine unit is mounted to the support structure via a clamp mount system requiring no drilling or permanent modification to the support structure. In tidal and river deployments, the piling 542 passes through the center of the turbine unit along the longitudinal axis. Sealing collars 530 and 531 maintain watertight static seals against the outer diameter of the piling 542 at the top and bottom ends of the unit respectively.

### 2. Inner Rubber Cushion 104

In tidal and river deployments, the inner rubber cushion 104 comprises marine-grade ethylene propylene diene monomer (EPDM) rubber and is positioned immediately outward of the piling 542. The inner rubber cushion 104 cushions the bridge piling against vibration and impact forces transmitted through the turbine assembly during operation. The inner rubber cushion 104 is fixed and does not rotate.

### 3. Inner Rubber Vibration Isolation Layer 106

In tidal and river deployments, the inner rubber vibration isolation layer 106 comprises silicone aerogel composite material and is positioned immediately outward of the inner rubber cushion 104. The silicone aerogel construction provides full vibration decoupling between the inner rubber cushion 104 and the inner carbon fiber structural cylinder 108. The material is compression-set resistant, maintaining its damping properties throughout the operational life of the unit. The inner rubber vibration isolation layer 106 is fixed and does not rotate.

### 4. Inner CF Structural Cylinder 108

In tidal and river deployments, the inner CF structural cylinder 108 comprises a carbon nanotube (CNT)/ultra-high molecular weight polyethylene (UHMWPE) composite tube and serves as the primary inner structural wall of the turbine unit. The CNT/UHMWPE construction provides approximately ten times the tensile strength of steel with corrosion resistance and reduced weight. In certain embodiments, the inner bore face of the inner CF structural cylinder 108 incorporates a graphene-aluminum infused carbon fiber lining providing enhanced thermal conductivity and corrosion resistance at the fluid-contacting surface. The inner CF structural cylinder 108 is fixed and does not rotate. A sealed wiring port 128 passes through the outer housing 124 to route electrical output from the electromagnetic machine 116 to an inverter 126 mounted external to the sealed housing.

### 5. CF Blade Tube 110

The CF blade tube 110 is the only rotating part of the turbine unit. The blade tube 110 has an inner cylindrical face 552, with blades extending radially inward. The blade tube 110 is configured to extract kinetic energy from fluid flowing through the annular flow channel 130. The blade tube 110 splits at the centerline to permit installation around existing structural elements such as bridge pilings 542 without requiring the support structure to be threaded through the tube. The split halves are joined and sealed at the junction upon assembly, the watertight seal at the junction maintaining fluid isolation of all layers inward of the blade tube 110 while permitting rotation of the assembled blade tube halves as a unified assembly.

### 6. Ball Bearing Array 112

The ball bearing array 112 comprises CNT-ceramic hybrid bearing elements arranged in a plurality of rows. The bearing array 112 is sandwiched between the outer face of the blade tube 110 and the inner face of the CF bearing housing 114, enabling low-friction rotational movement of the blade tube 110 relative to the fixed bearing housing 114. The CNT-ceramic hybrid construction is dry-rated and maintains ultra-low friction in both submerged and aerial deployment environments. The bearings may have any suitable configuration, such as spherical, cylindrical, conical, or tapered.

### 7. CF Bearing Housing 114

The CF bearing housing 114 comprises Dyneema® ultra-high molecular weight polyethylene fiber composite and serves as the outer wall of the bearing sandwich. The bearing housing 114 is fixed and does not rotate. The bearing housing 114, in cooperation with the annular race of the blade tube 110 and the retainer 60 positioned adjacent to the roller bearings 54, maintains precise alignment of the bearing elements and prevents displacement under varying load conditions.

### 8. Electromagnetic Motor 116

The electromagnetic motor 116, also referred to as an electromagnetic machine and an electromagnetic generator, comprises a plurality of neodymium iron boron (NdFeB) N52 permanent magnets arranged in a three-dimensional carbon fiber lattice, sandwiched between carbon fiber walls. The motor 116 is hermetically sealed and completely dry during operation—no fluid contacts the motor components in any deployment configuration. The motor 116 splits at the centerline to permit installation around existing structural elements, with complementary electrical connection interfaces that align and engage when the two halves are assembled. A watertight seal is provided along the junction between the segments to maintain proper electrical connections and prevent fluid intrusion.

In the embodiment of Section I, the electromagnetic motor 116 is disposed radially outward of the CF blade tube 110 and inward of layer 118, with the fluid-wetted region at the annular flow channel 130.

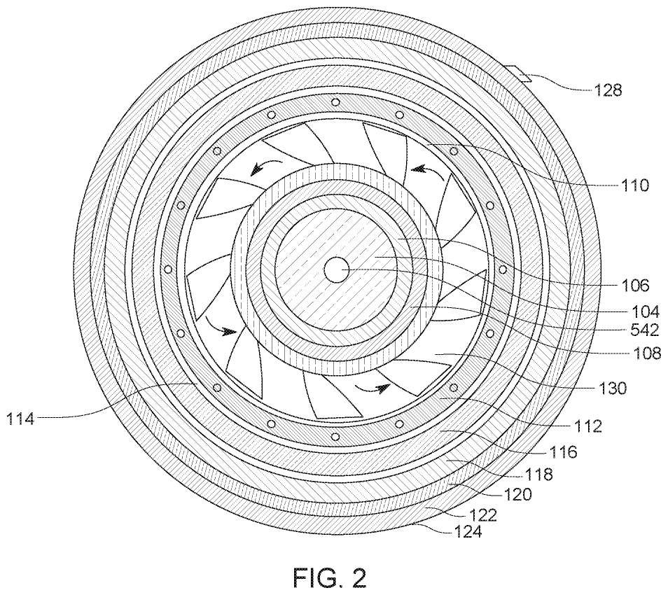

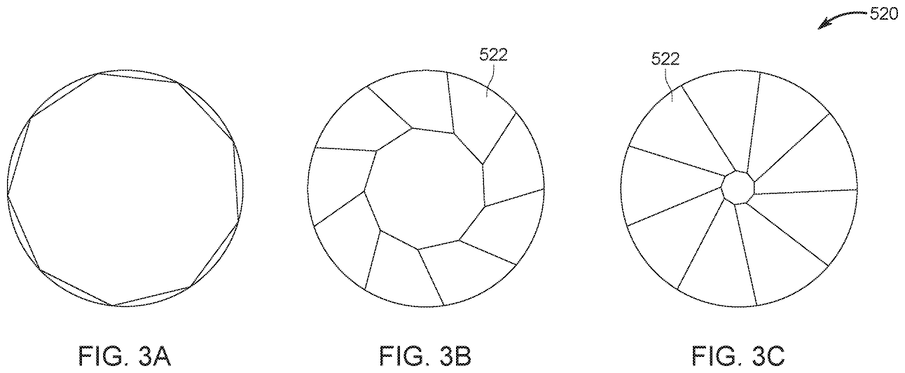

In some embodiments, the electromagnetic motor 116 may employ a rim-drive permanent magnet generator architecture of a class described in U.S. Patent Application Publication No. US 2010/0133844 A1 (Pearce), which illustrates, with reference to FIGS. 2B, 2C, 3B, and 3C thereof and paragraphs [0082] through [0084] thereof, one example of rotor magnet arrangement, flux-directing backing plate, stator coil configuration, and multi-phase output connection suitable for use in a rim-drive generator context. The disclosure of Pearce is incorporated herein by reference in its entirety.

In certain embodiments, the electromagnetic machine 116 is a scalable permanent-magnet configuration in which the blade tube 110 carries a permanent magnet array 564 as the rotor and the motor layer comprises wound stator coils as the stator. The active surfaces of the electromagnetic machine 116 are scalable: at minimum, the permanent magnets and stator windings occupy a narrow band at the rim of the blade tube 110, consistent with the rim-drive architecture described in Pearce. At maximum, the active surfaces span the full axial length of the blade tube 110 and extend across both end faces of the turbine unit as axial-gap active surfaces 565, capturing both radial-gap flux around the circumference of the blade tube 110 and axial-gap flux across the end faces. In such a full-span configuration, the electromagnetic machine 116 operates as a combined axial-radial-flux permanent-magnet machine. The term “electromagnetic machine 116” as used herein encompasses both the minimal rim-drive configuration and the full-span configuration and all intermediate configurations therebetween.

### 9. Heating, Cooling, and Control Layer 118

The heating, cooling, and control layer 118 is a dedicated discrete structural layer positioned outside the motor 116 and inside the outer rubber vibration isolation layer 120. The layer 118 is present in all embodiments of the turbine system. Its components, operating modes, and functions are described in detail in Section VII below.

### 10. Outer Rubber Vibration Isolation Layer 120

The outer rubber vibration isolation layer 120 comprises silicone aerogel composite material and is positioned between the layer 118 and the outer protective sleeve 122. The outer rubber vibration isolation layer 120 provides harmonic dampening between the inner electromechanical assembly and the outer fluid-facing layer, preventing resonant frequency transmission to the outer housing 124 and to adjacent infrastructure. The outer rubber vibration isolation layer 120 is fixed and does not rotate.

### 11. Outer Rubber Protective Sleeve 122

The outer rubber protective sleeve 122 faces the environment directly and provides impact protection from fluid-side forces including debris strikes. In tidal and river deployments, the outer rubber protective sleeve 122 comprises marine-grade EPDM rubber. In vehicle and aircraft embodiments, the outer isolation layer comprises a material appropriate to the deployment environment. The outer rubber protective sleeve 122 is fixed and does not rotate.

### 12. Outer Housing 124

In some embodiments, the outer housing 124 defines the outermost structural boundary of the turbine unit in tidal, river, and pipe inline deployments. All inner layers of the turbine unit are circular in cross-section and concentric within the outer housing 124. The cylindrical geometry distributes tidal and current forces uniformly around the circumference. In certain embodiments, a plurality of turbine units are assembled in a tiled array on a single pre-existing support structure, with spacing between adjacent units configured to permit fluid access to the scroll chambers and bidirectional flow gate assemblies at each end of each unit. A carbon fiber honeycomb composite mesh may be used for debris screening at fluid inlet faces as described in Section VI, applied as a flat screen element at inlet openings.

### II. Spiral Volute Inlet System

### A. Overview and Functional Purpose

Referring to FIGS. 1A, 1B, 3C, 4A, 4B, and 5, the spiral volute inlet system comprises a scroll chamber formed at each fluid inlet of the sealed cylindrical turbine housing. In the tidal embodiment shown in FIGS. 1A-1B, an upper scroll chamber 510 and a lower scroll chamber 511 are disposed at the opposing fluid inlets of the unit, each with a horizontal side port opening—upper side port 515 and lower side port 514 respectively—oriented to receive tidal current. The scroll chamber serves two functions: it accelerates incoming fluid from ambient velocity to a substantially higher velocity at the blade inlet zone 146, and it pre-rotates the fluid in the blade rotation direction before any blade contact occurs. Computational modeling indicates the scroll chamber geometry produces a velocity increase of approximately 2.9 times ambient velocity at the blade inlet zone 146. This acceleration results from conservation of mass: as the cross-sectional area of the converging scroll channel decreases continuously from the entry throat 512 to the blade inlet zone 146, the fluid velocity must increase proportionally to maintain continuity of flow, consistent with the continuity equation for incompressible flow. No energy is created in this process; the scroll converts the pressure head of the incoming tidal current into velocity head at the blade inlet zone 146. Since fluid power scales at the cube of velocity, this velocity increase produces substantially more power extraction than a flat-face inlet of equivalent diameter.

The spiral volute inlet system is informed by the Francis turbine scroll case architecture, which has an established lineage in hydroturbine engineering. The present spiral volute system is distinguished from Francis turbine prior art in three respects: (a) the tidal embodiment employs bidirectional mirrored scroll chambers 510 and 511 at both fluid inlets of the turbine rather than a single unidirectional inlet, enabling continuous power generation through tidal reversal; (b) the blade architecture is inverted, with blades rooting to the inner cylindrical face 552 of the rotating blade tube 110, enabling installation around existing infrastructure; and (c) fluid flow direction is governed by passive flow gate assemblies which may have the form of irises 520 and 521 responding to pressure differential, without requiring active control systems.

### B. Structural Description—Axial End Cap Configuration

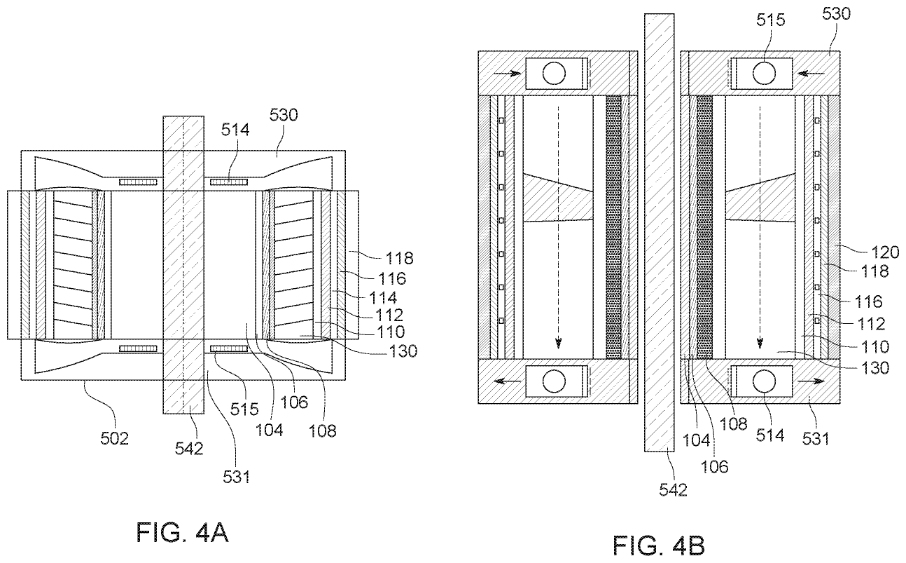

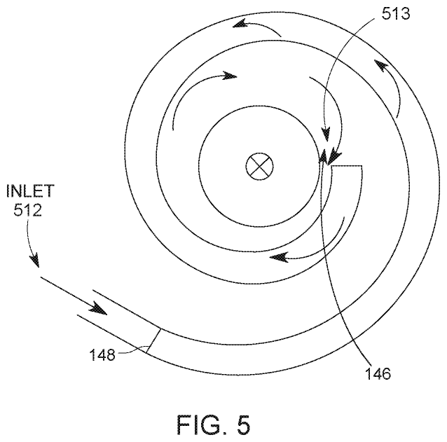

In one embodiment, the scroll chamber is formed as an annular end cap disposed at each axial end of the sealed cylindrical turbine housing. Referring to FIG. 4A, each annular end cap comprises an outer wall 502, a spiral volute scroll 510 narrowing from a tangential entry throat 512 to a cutwater 513 where the spiral transitions to the blade inlet zone 146, a flow gate ring 520 with petals 522, and a sealing collar 530 configured to maintain a watertight static seal against the outer diameter of the piling 542 passing through the piling bore. The irising flow gate 520 is disposed between the blade inlet zone 146 and the blade tube 110. A HexWeb CF screen 148 is disposed across the inlet mouth at entry throat 512 to prevent marine debris and marine life from entering the scroll chamber. In certain embodiments, the spiral channel follows a continuously narrowing spiral path, which may be logarithmic, Archimedean, or a hybrid profile, completing approximately 360 degrees of rotation from the entry throat 512 to the blade inlet zone 146, as shown in FIG. 5.

### C. Structural Description—Side-Wall Scroll Configuration

In an alternative embodiment shown in FIGS. 1A and 1B, the scroll chambers 510 and 511 are formed as toroidal bodies wrapped around the side wall of the turbine housing, with horizontal side ports 514 and 515 oriented to receive tidal current flowing laterally past the piling 542. In this configuration, fluid enters through the side port and travels circumferentially through the scroll chamber, decreasing in cross-sectional area as it wraps around the cylinder, developing angular momentum about the turbine axis before entering the annular flow channel 130 and contacting the blade tube 110. The irising flow gate 520 or 521 is disposed at the side port opening in this configuration, opening to admit fluid when upstream pressure exceeds the opposing pressure and closing to block reverse flow.

The upper scroll chamber 510 and lower scroll chamber 511 are oriented with their respective side ports 514 and 515 on opposing sides of the turbine housing such that fluid entering from either tidal direction is directed into the appropriate scroll chamber and pre-rotated in the same rotational direction relative to the blade tube 110. Claims reciting a spiral channel, pre-rotation, and bidirectional flux valve actuation encompass both the axial end-cap and the side-wall scroll configurations.

### D. Hydrodynamic Operation

Fluid entering the scroll chamber develops angular momentum about the turbine central axis as it travels along the spiral channel path toward the blade inlet zone 146. The pressure differential across the converging scroll actively draws fluid inward, creating a suction effect at the entry throat 512.

Pre-rotating fluid enters the central bore already spinning in the same direction as the blade tube 110. The blade tube 110 receives fluid with additive angular momentum rather than static fluid, increasing effective torque and power extraction.

### E. Bidirectional Dual-Scroll Configuration

In the tidal embodiment, the upper scroll chamber 510 and lower scroll chamber 511 are mirror images of each other, spiraling in opposite directions, such that fluid entering from either the upper side port 515 or the lower side port 514 is angularly accelerated in the same rotational direction relative to the blade tube 110. When the tidal direction reverses and the irising flow gates 520 and 521 switch the active inlet, the scroll chamber on the newly active inlet pre-spins the incoming fluid in the same rotational direction as the previously active scroll chamber did during the preceding tidal phase. The blade tube 110 therefore continues rotating in the same direction regardless of which inlet is active, enabling uninterrupted electricity generation throughout the full tidal cycle.

### F. HexWeb CF Water Inlet Screen 148

A HexWeb CF water inlet screen 148 is disposed at the entry throat 512 of each scroll chamber. The screen 148 comprises hexagonal carbon fiber honeycomb mesh with cell dimensions configured to permit water flow while blocking marine debris, marine life, plant matter, and inorganic particulate matter. The carbon fiber construction is saltwater corrosion resistant and ultraviolet resistant. The layer 118 maintains the screen 148 above freezing temperature in cold water deployments. The bidirectional nature of tidal flow provides automatic self-cleaning of the screen surface each tidal cycle.

### G. Computational Performance Estimates and the Betz Limit

Computational fluid dynamics (CFD) modeling of the spiral volute and blade ring geometry is used to evaluate the hydrodynamic performance of the system. The power output of a given unit is design-dependent and is not a fixed value: consistent with conservation of energy, the power available to a unit scales with the kinetic energy flux through the capture area presented to the flow and with the cube of the local flow velocity, such that output is determined by the unit's capture area, the site current velocity, and the installation geometry. Because the system is intended for installation on existing infrastructure at sites having predictable, recurring tidal or current flows, a principal performance objective is a high and predictable capacity factor relative to intermittent generation sources, rather than peak nameplate output. The modeled operational velocity envelope spans a cut-in velocity of approximately 0.5 meters per second, a rated velocity of approximately 3.0 meters per second, and a cut-out velocity of approximately 4.5 meters per second.

The Betz limit establishes a theoretical maximum power-extraction coefficient of approximately 59.3 percent for an open rotor operating in an unbounded free-stream flow, referenced to the rotor swept area. That coefficient is derived for a free-stream rotor having unconstrained bypass flow around the rotor disk. The present turbine instead operates within a sealed cylindrical duct, in which fluid passing through the annular flow channel is directed to the blade ring with reduced bypass. As recognized in the fluid mechanics literature for ducted and diffuser-augmented turbines, such configurations can achieve a power coefficient, referenced to the rotor swept area, that is greater than the open-rotor Betz coefficient, because the surrounding duct and the spiral volute scroll increase the mass flow presented to the rotor. The system nonetheless remains subject to conservation of energy: the power that can be extracted is bounded by the kinetic energy flux of the flow passing through the capture area of the unit, and the ducted geometry serves to redistribute and augment the flow through the rotor rather than to create energy.

### III. Bidirectional Flow Gate System

### A. Overview and Functional Purpose

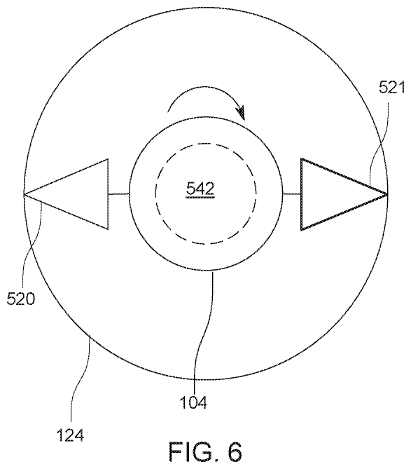

Referring to FIGS. 3A, 3B, 3C, and 6, the bidirectional flow gate system comprises flow gate assemblies disposed at inlet mouth of each spiral volute scroll case of the tidal turbine housing. In the sidewall scroll configuration shown in FIGS. 1A and 1B, a first flow gate assembly is disposed at the upper side port 515 and a flow gate assembly is disposed at the lower side port 514. In the axial end-cap configuration, the first flow gate assembly is disposed at one axial end and the second flow gate assembly at the other. Each flow gate assembly selectively permits or blocks fluid entry into its respective spiral volute scroll in response to fluid pressure differential, such that during tidal flow, with one inlet operates as the active fluid inlet while the other is sealed.

In certain embodiments, each flow gate assembly comprises a passive check valve actuated solely by fluid pressure differential, requiring no mechanical actuation, sensor input, or control signal for normal tidal operation. In certain embodiments, each flow gate assembly comprises an actively controlled iris valve 520 comprising a plurality of movable iris elements 522 disposed across the volute inlet mouth and driven by an actuator controlled by the control layer 118, as shown in FIG. 3C. In certain embodiments, each flow gate assembly comprises both a passive check valve for normal tidal directional control and a supplemental iris valve for active storm lockdown. The claims of the present invention encompass all such configurations of the flow gate assembly.

### B. Three Operating States

### State 1—First Tidal Phase (Flood)

Referring to FIG. 1B and FIG. 6, during the flood tidal phase, tidal current approaches the turbine from the first side. The pressure differential opens the first flow gate assembly 520 and simultaneously holds the second flow gate assembly 521 closed. Fluid enters through the first flow gate assembly, passes through the upper scroll chamber 510, and contacts the blade tube 110. The blade tube 110 rotates in a first rotational direction, as indicated by a rotation arrow. In embodiments employing passive check valves, no mechanical actuation, sensor input, or control signal is required to maintain valve positions during tidal flow—the pressure differential self-maintains the correct valve positions. In embodiments employing actively controlled iris valves, the control layer 118 monitors pressure differential and maintains the appropriate valve states.

### State 2—Second Tidal Phase (Ebb)

Referring to FIG. 1A and FIG. 6, during the ebb tidal phase, tidal current reverses direction. The pressure differential opens the second flow gate assembly 521 and simultaneously holds the first flow gate assembly 520 closed. Fluid enters through the second flow gate assembly, passes through the lower scroll chamber 511, and contacts the blade tube 110. The lower scroll chamber 511 is a mirror image of the upper scroll chamber 510, spiraling in the opposite direction, such that the incoming fluid is pre-rotated in the same first rotational direction as during the flood phase. The blade tube 110 continues rotating in the same first rotational direction. Uninterrupted electricity generation is maintained throughout the tidal reversal.

### State 3—Storm and Surge Protection

Referring to FIG. 3B, during storm surge, hurricane conditions, or abnormally high hydrodynamic loading events, both flow gate assemblies are simultaneously driven to the closed position, fully sealing the turbine unit against fluid ingress. The control layer 118 detects a fluid pressure differential, flow velocity, or vibration level exceeding a predetermined threshold via the flux valve pressure sensor and actively drives both flow gate assemblies to the closed position, regardless of prevailing fluid pressure differential. In embodiments employing passive pressure-differential actuation check valves, a supplemental active lockout mechanism driven by the control layer 118 closes both flow gate assemblies simultaneously upon detection of the condition exceeding the predetermined threshold. The turbine unit is fully sealed in this state: zero fluid ingress, no moving parts exposed, blade tube 110 stationary, motor 116 not running. The control layer 118 monitors conditions continuously and actively reopens the appropriate flow gate assembly when conditions return to within the operational range, restoring electricity generation without maintenance intervention.

### C. Combined Scroll and Flow Gate Operation

The spiral volute inlet system and the bidirectional flow gate system operate in sequence on each tidal cycle as an integrated water entry system. First, tidal current approaches from one direction. Second, the active flow gate assembly opens the upstream volute inlet and seals the downstream inlet. Third, incoming water enters the open scroll chamber. Fourth, the scroll pre-spins the water tangentially, developing angular momentum in the blade rotation direction before any blade contact. Fifth, pre-spun water exits the scroll throat into the central bore. Sixth, fully pre-accelerated water contacts the blade tube 110 with additive angular momentum, increasing torque on the generator. Seventh, on tidal reversal, the flow gate assemblies switch, the previously sealed inlet becomes the active inlet and its scroll becomes the active pre-spinner, and the blade tube 110 continues spinning in the same direction.

### D. Flow Gate Assembly Configurations

The flow gate assembly disposed at each volute inlet mouth may take any configuration capable of selectively permitting or blocking fluid entry in response to fluid pressure differential. In a first configuration, the flow gate assembly comprises a passive check valve comprising one or more valve elements that open under positive pressure differential in the inlet direction and close under reverse pressure differential, requiring no active control for normal tidal operation. In a second configuration, the flow gate assembly comprises an actively controlled iris valve 520 comprising a plurality of movable iris elements 522 arranged across the volute inlet mouth, the iris elements movable between a fully open position and a closed position, driven by an actuator controlled by the control layer 118. In a third configuration, the flow gate assembly comprises both a passive check valve for normal tidal directional control and a supplemental actively controlled iris valve for storm lockdown, the passive check valve handling tidal phase switching and the iris valve providing active closure capability independent of fluid pressure differential. The invention encompasses all such configurations and equivalents thereof.

In embodiments employing passive check valves, check valve comprises a valve body 544 mounted to the spiral volute at the volute inlet mouth, a flap 550 pivotably mounted to the valve body 544 on a spring-loaded hinge pin 546 that biases the flap 550 to the closed position, and a seal gasket 554 disposed on the valve body seating surface. The flap opens under positive pressure differential in the inlet direction, admitting fluid into the scroll chamber, and returns to the closed position under reverse pressure differential or under return spring force when pressure differential is below the opening threshold. The passive check valve requires no electrical actuation, sensor input, or control signal for normal tidal operation.

### IV. Blade Geometry

### A. Tidal Blade Strips—General Description

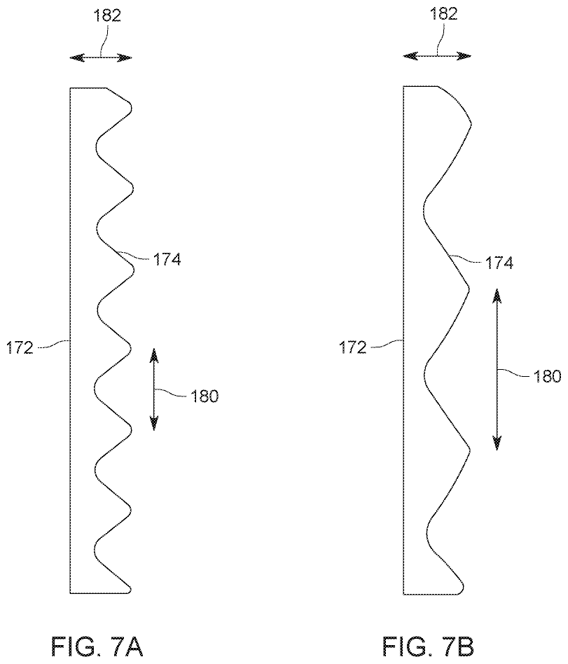

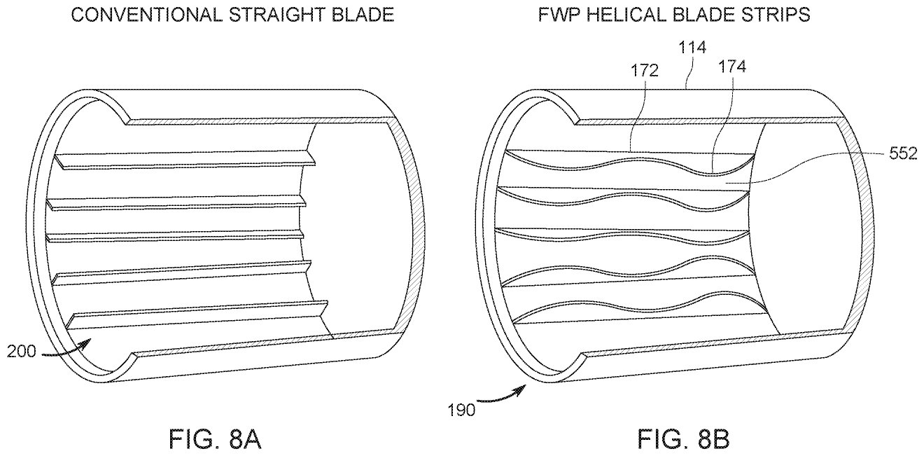

Referring to FIGS. 7A, 7B, 8A, and 8B, the tidal turbine blade assembly comprises a plurality of full-span corrugated blade strips extending the full axial length of the blade tube 110. Each blade strip has two longitudinal edges: a straight root edge 172 and a non-planar free edge 174. The straight root edge 172 is planar and bonds to the inner cylindrical face 552 of the blade tube 110 along the full height of the strip. The non-planar free edge 174 faces the center of the assembly. Fluid flowing through the annular flow channel 130 impinges upon the non-planar free edge 174, generating rotational torque on the blade tube 110. In certain embodiments, the non-planar free edge 174 is sinusoidal.

In certain embodiments, each tidal blade strip is mounted on a pivot pin disposed at the straight root edge of the blade strip, the pivot pin running parallel to the longitudinal axis of the blade tube 110. A passive cam mechanism is mechanically linked to the actuation motion of the irising flow gate 520 or 521 such that when the flow gate transitions between its open and closed states, the cam mechanism simultaneously rotates each blade strip on its pivot pin from a first pitch position to a mirrored second pitch position. The first pitch position presents a predetermined blade angle of attack for fluid flow entering from the first fluid inlet, and the second pitch position presents a predetermined blade angle of attack for fluid flow entering from the second fluid inlet. This variable pitch mechanism further supports unidirectional rotation of the blade tube 110 through the tidal cycle. The cam mechanism is entirely passive, requiring no active motor, solenoid, or sensor input—the cam is driven solely by the mechanical motion of the valve actuation.

### B. T-A Embodiment—First Tidal Blade Strip

Referring to FIG. 7A, the first tidal blade strip embodiment T-A has a narrow blade width 182 from the straight root edge 172 to the non-planar free edge 174. The non-planar free edge 174 has a short tight wave cycle 180 with multiple wave cycles occurring along the full blade height. T-A is optimized for weaker and slower current conditions of approximately 1.0 to 1.8 meters per second.

### C. T-B Embodiment—Second Tidal Blade Strip

Referring to FIG. 7B, the second tidal blade strip embodiment T-B has a blade width 182 approximately twice that of T-A, spanning deeper into the annular flow channel 130 from the root to the free edge. The non-planar free edge 174 of T-B has a longer wave cycle 180 with fewer cycles along the full blade height. T-B is optimized for stronger and faster current conditions of approximately 1.8 to 3.5 meters per second. Both T-A and T-B are constructed from graphene-aluminum carbon fiber (GA-CF) material, have the same full-tube height, and share the same straight root edge 172 bonding geometry.

### D. W-A Embodiment—First Wind Turbine Blade

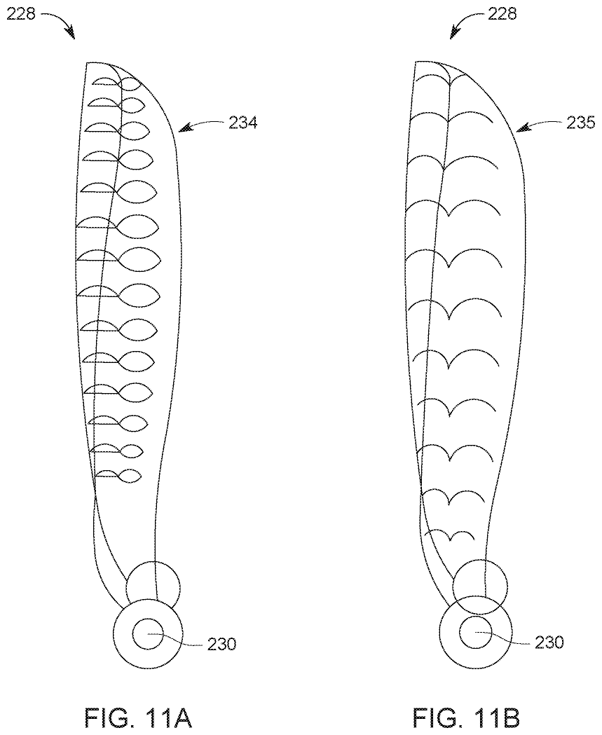

Referring to FIG. 11A, the first wind turbine blade embodiment W-A has a leaf or feather planform profile. The blade surface carries short-wave overlapping scallop ridges 234. A circular root ball 230 at the base of the blade attaches to the inner face of the Ring 2 blade tube. The circular root ball 230 is the distinguishing structural mounting feature of wind blade embodiments relative to tidal blade embodiments, which use a straight root edge 172. W-A is optimized for lighter wind conditions of approximately 5 to 12 meters per second.

### E. W-B Embodiment—Second Wind Turbine Blade

Referring to FIG. 11B, the second wind turbine blade embodiment W-B shares the same leaf or feather planform profile and circular root ball 230 as W-A. The blade surface of W-B carries a sinusoidal wave profile 235 with larger amplitude corrugations providing greater surface interaction with stronger wind conditions of approximately 12 to 25 meters per second.

### F. HEX Chain Blade Embodiment

The HEX Chain blade embodiment comprises a
an elongated strip having a long root edge and a long free edge. The root edge is a flat flanged plate bonded to the inner cylindrical face 552 of the blade tube 110 along an axial or helical sweep from the first axial end to the second axial end of the blade tube 110. The free edge is sinusoidal and faces the fluid flow, consistent with the T-A and T-B tidal blade embodiments.

The working face of the blade strip comprises a plurality of shallow hexagonal prism cells approximately 8 to 12 millimeters across the flats, tiling the blade surface in a honeycomb relief pattern. Adjacent cells are fused at shared walls with no gaps, forming one continuous rigid panel pre-formed in a mold. The hexagonal cell geometry stiffens the blade panel while the faceted cell surfaces generate vortex shedding from the flow. The hexagonal columns run span-wise from the root edge to the free edge.

The HEX Chain embodiment is intended for river, slow estuary, pipe inline, and experimental applications where structural rigidity under sustained unidirectional flow loading is prioritized.

In alternative embodiments, adjacent hexagonal cells are joined by flexible linkages permitting articulation between cells.

### G. Helical Blade Arrangement

Referring to FIG. 8A, the figure shows the helical blade strip arrangement 190 in which each blade strip follows a helical path along the inner cylindrical face 552 of the blade tube 110. The root edges 172 of each strip are bonded to the inner cylindrical face 552 along the helical path from a first axial end to a second axial end of the blade tube. The sinusoidal free edges 174 face the center of the assembly at positions along the tube length simultaneously, creating a continuous engagement zone along the bore.

FIG. 8B shows a conventional straight-blade configuration with dead zones 200 between adjacent strips. The helical arrangement eliminates dead zones 200 by ensuring that blade surface is engaged with fluid at multiple axial positions simultaneously, providing more continuous torque, lower startup velocity, and smoother rotation. The helical arrangement applies to all deployment environments.

### V. Wind Turbine Embodiment—Dual-Ring Passive Swivel System

### A. Overview

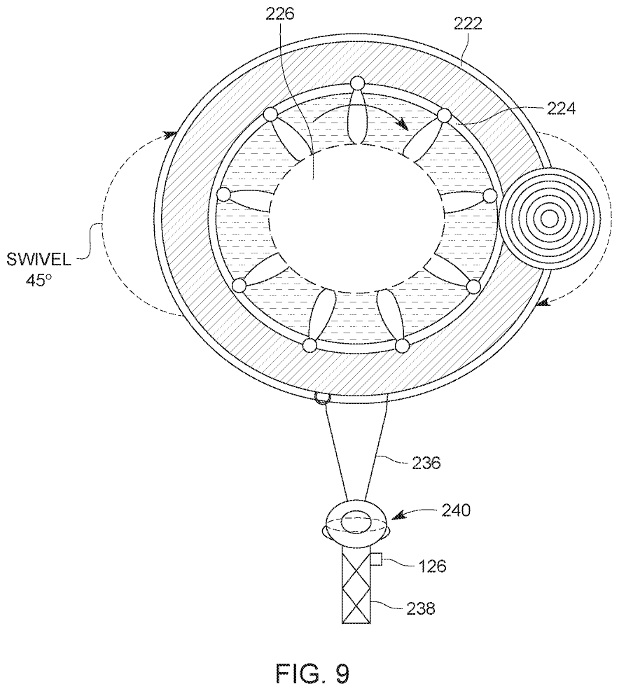

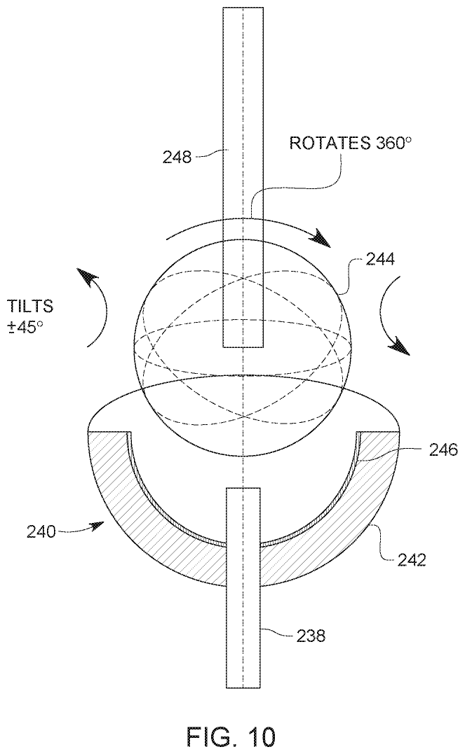

Referring to FIGS. 9 and 10, the wind turbine embodiment employs the same core layer architecture as the tidal cylindrical embodiment, configured in a toroidal ring form factor and mounted on an existing power pole 238 or lattice tower structure using a passive omnidirectional swivel joint 240. The wind turbine assembly comprises Ring 1 222, the outer swivel housing ring, which passively self-orients to face the wind from any direction by rotating about a first axis defined by the swivel joint 240, and Ring 2 224, the inner blade tube ring, which spins continuously from wind force to generate electricity by rotating about a second axis defined by the turbine bore axis. These two axes of rotation are independent. No new construction or foundation work is required for installation.

### B. Ring 1—Outer Swivel Housing

Ring 1 222 is the outer toroidal housing ring of the wind turbine, mounted on the passive omnidirectional swivel joint 240 connecting the turbine assembly to a support arm 236 extending from the power pole 238. Wind pressure acting on the curved surface of Ring 1 222 creates aerodynamic torque on the swivel joint 240, causing Ring 1 222 to rotate passively until it faces directly into the wind. No active motor, sensor, or control system is required for wind-direction tracking.

### C. Passive Swivel Joint Detail

Referring to FIG. 10, the passive swivel joint 240 comprises a socket 242 fixed to the power pole and a ball 244 attached to the support arm extending to Ring 1 222. The ball 244 rotates freely inside the socket 242, permitting 360-degree rotation in the horizontal plane and tilt in any direction up to plus or minus 45 degrees. A UHMWPE low-friction bearing surface 246 between the ball and socket provides smooth rotation under wind loading without requiring lubrication. A sealed wiring channel 248 passes through the center of the joint to route electrical output from Ring 2 224 through the support arm to the external inverter 126. The wiring channel 248 incorporates a slip ring assembly configured to accommodate rotation of the swivel joint 240 without twisting or breaking the wiring. Zero energy is consumed by the orientation tracking function.

### D. Ring 2—Inner Blade Tube Ring

Ring 2 224 is the inner blade tube ring and contains the same layer architecture as the tidal cylindrical embodiment: rubber isolation layers, CF structural layer, ball bearing assembly 112, electromagnetic motor 116, and layer 118. Wind leaf blades 228 are mounted on the inner face of the Ring 2 blade tube via circular root balls 230. Wind entering the toroidal ring body contacts the inward-facing leaf blades 228, rotates Ring 2 224 about the turbine bore axis, and drives the motor 116 to generate electricity. Ring 2 224 continues spinning and generating electricity throughout all Ring 1 222 reorientation events.

### E. Open Center Bore

The center of the toroidal ring housing defines an open center bore 226 that passes through the turbine assembly. The open center bore 226 presents zero obstruction to birds and wildlife. No blade, mesh, or structural element occupies the center bore 226.

### F. Wind Turbine Face Grate

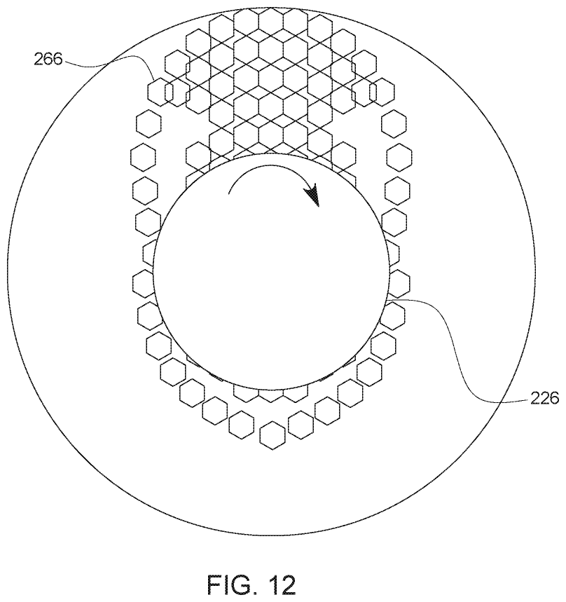

Referring to FIG. 12, in certain embodiments a HexWeb CF mesh face grate 266 is disposed on the wind-facing face of the toroidal Ring 1 222 housing, covering the annular blade zone between the outer ring boundary and the open center bore 226. The grate 266 comprises hexagonal carbon fiber honeycomb mesh with cells sized to permit air flow while stopping debris ingestion. Cell dimensions are in the range of 8 to 12 millimeters across flats. The center bore 226 is left unobstructed by the grate 266.

### G. Omnidirectional Operation

The passive swivel joint 240 permits the wind turbine to capture energy from wind arriving from any direction in the horizontal plane and from updrafts and downdrafts within the tilt range of the swivel joint 240. This omnidirectional wind capture capability distinguishes the present wind turbine embodiment from conventional horizontal-axis wind turbines, which require active yaw motors and sensors and cannot capture updrafts or downdrafts.

### H. Inter-Piling Wind Corridor Configuration

In certain embodiments, one or more wind turbine units are mounted to a support structure spanning between two or more adjacent bridge pilings or structural columns above the waterline, with the turbine units positioned in the wind corridor between the pilings. This configuration utilizes the same turbine units as all other wind embodiments—no additional structural components are required.

### VI. Hexagonal Carbon Fiber Mesh Grate System

### A. Overview

A hexagonal carbon fiber honeycomb mesh grate system is deployed in three distinct locations across the turbine platform: the wind turbine annular face grate 266, the fluid inlet grate at vehicle, pipe, and aircraft inlets, and the spiral volute water inlet screen 148. The hexagonal cell geometry provides substantial open area for fluid flow while blocking biological and inorganic debris. HexCel® HexWeb® carbon fiber honeycomb composite is the preferred material for all three grate locations.

### B. Wind Turbine Face Grate 266

In the wind turbine embodiment, the HexWeb CF mesh face grate 266 is disposed on the wind-facing face of the toroidal Ring 1 222 housing, covering the full annular blade zone between the outer ring boundary and the open center bore 226. The mesh provides structural rigidity to the face of the ring housing. The center bore 226 is left completely unobstructed.

### C. Fluid Inlet Grate

In vehicle, pipe inline, and aircraft nacelle deployment environments, a HexWeb CF mesh grate is disposed on the fluid inlet face of the turbine unit. In the aircraft nacelle application, the foreign object debris (FOD) grate 376 provides foreign object debris protection against ice crystals, runway debris, and bird strike across the full inlet face.

### D. Spiral Volute Water Inlet Screen 148

The water inlet screen 148 is disposed at the entry throat 512 of the scroll chamber at the point where tidal water enters the turbine. All fluid entering the turbine passes through this screen. The HexWeb CF construction provides saltwater corrosion resistance and ultraviolet resistance. Tidal reversal provides automatic self-cleaning of the screen surface each tidal cycle.

### VII. Heating, Cooling, and Control Layer

### A. Structural Position

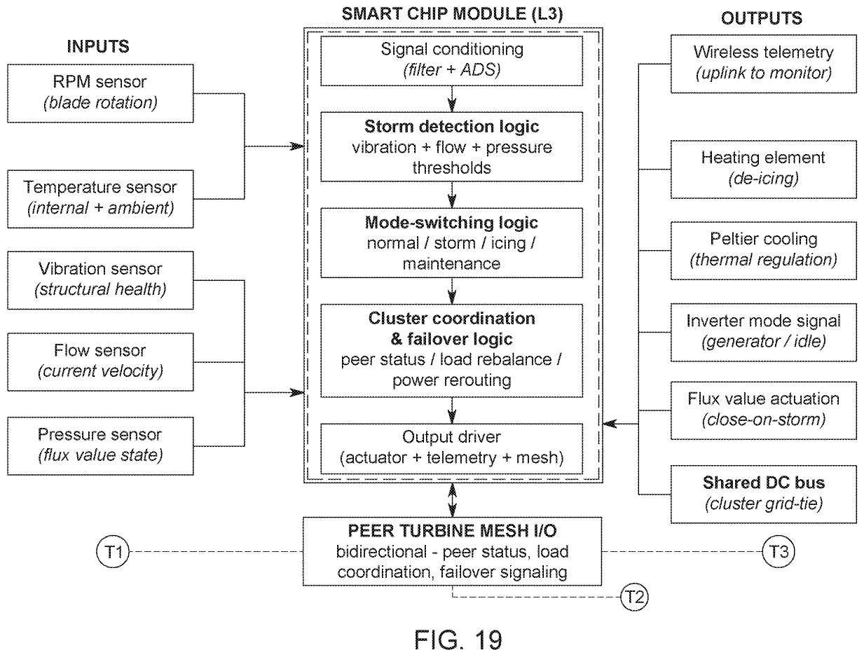

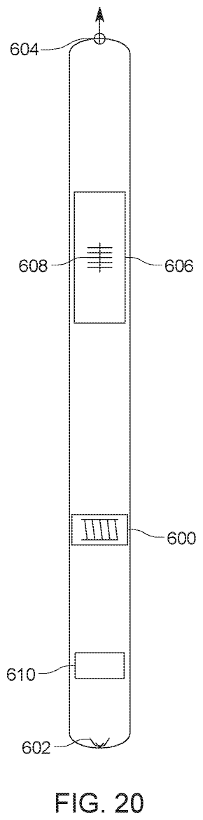

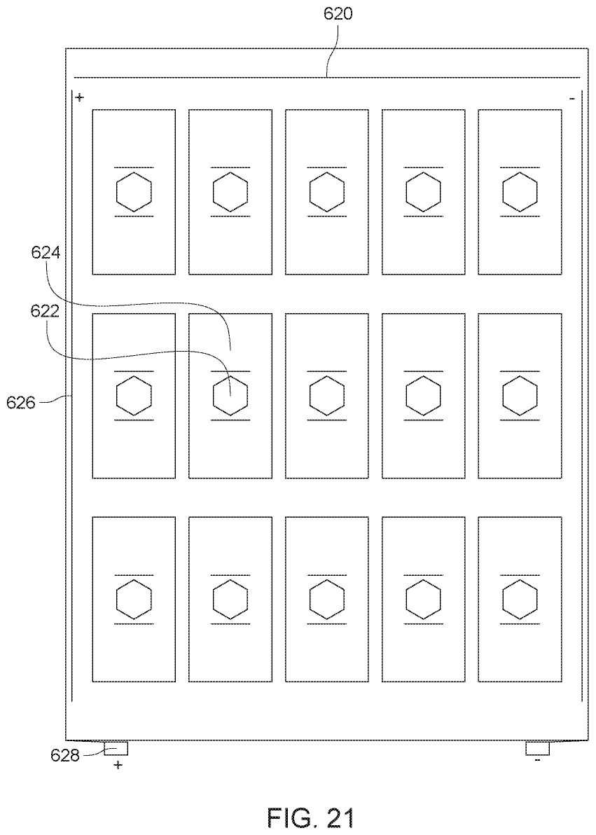

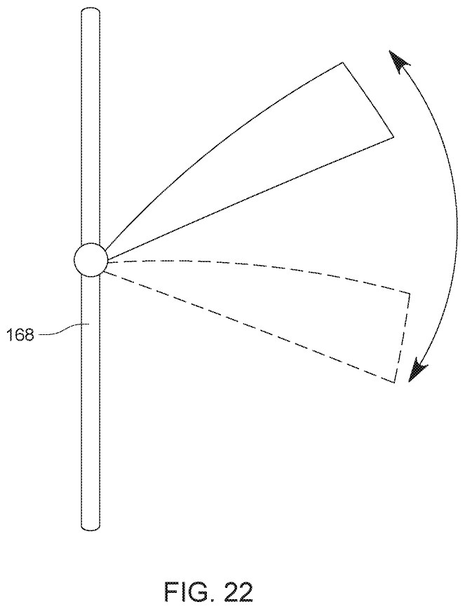

Referring to FIG. 19, the heating, cooling, and control layer 118 is a dedicated discrete structural layer of the turbine unit, positioned immediately outside the motor 116 and immediately inside the outer rubber vibration isolation layer 120. This layer 118 is entirely separate from the motor 116. The layer 118 is present in all embodiments of the turbine system.

### B. Components

The layer 118 comprises the following components integrated into a UHMWPE substrate: a heating and cooling management system; a smart chip microcontroller; an RPM sensor; a temperature sensor; a vibration sensor; a flow velocity sensor; a flux valve pressure sensor; a BLE wireless telemetry module; a LoRa long-range wireless telemetry module; and sealed wiring routed through the sealed wiring port 128 to the external inverter 126. The layer 118 maintains operational performance across a temperature range of −40° F. to +200° F.

In certain embodiments, the outputs of the smart chip microcontroller further comprise a blade-pitch actuator output that drives one or more blade-pitch actuators 168 to set the pitch angle of variable-pitch blades carried by the CF blade tube 110 in accordance with a then-current fluid-flow direction. In such embodiments the functional block diagram of FIG. 19 includes the blade-pitch actuator output among the actuator outputs of the Smart Chip Module.

### C. Internal Processing

The smart chip microcontroller comprises a signal conditioning stage that filters and digitizes the sensor inputs, followed by three principal logic stages: storm detection logic, mode-switching logic, and cluster coordination logic. The storm detection logic evaluates the combined vibration, flow velocity, and flux valve pressure sensor inputs against predetermined thresholds to determine the onset of storm surge or abnormal flow conditions. The mode-switching logic manages transitions among five operating modes: NORMAL, STORM, ICING, FAILOVER, and MAINTENANCE. The cluster coordination logic manages bidirectional peer-to-peer mesh communication with microcontrollers in neighboring turbine units, with connectivity to neighboring turbine nodes T1 and T3 via the peer mesh input/output (I/O) bus as shown in FIG. 19

### D. Operating Modes

In NORMAL mode, the turbine generates electricity, all sensors are monitored at standard polling intervals, and telemetry is transmitted at the scheduled interval.

In STORM mode, the storm detection logic has determined that the pressure differential exceeds the predetermined storm threshold, both irising flow gates 520 and 521 are actively driven to the closed position, the blade tube 110 is stationary, and no electricity is generated. The microcontroller continues monitoring pressure conditions and executes automatic transition back to NORMAL mode with the appropriate valve open when the pressure differential returns below the threshold.

In ICING mode, the heating element is activated, electricity output is reduced, and the peer mesh redistributes the reduced load to neighboring units that remain at full output.

In FAILOVER mode, the unit drops off the shared DC bus, ceases generation, and signals neighboring units via the peer mesh to auto-compensate by increasing their individual loads.

In MAINTENANCE mode, all actuators are held idle, full sensor telemetry is transmitted at maximum polling rate, and the unit is isolated from the shared DC bus to permit inspection.

### E. Functions

The thermal management function maintains all inner components of the turbine unit within their operational temperature ranges regardless of ambient conditions or motor 116 heat generation. In cold Arctic and sub-Arctic tidal deployments, heating elements prevent freezing of mechanical components, seals, and the water inlet screen 148. In high-output operation, cooling channels dissipate motor heat.

The performance monitoring function provides real-time data on RPM, temperature, vibration, flow velocity, and flux valve pressure. Predictive algorithms anticipate maintenance requirements before performance degradation occurs.

In tidal deployments, the storm protection function enables the third state of the irising flow gates 520 and 521 as described in Section III. B.

In marine hull deployments, the mode switching function controls the generator-to-thruster mode transition. The microcontroller executes the mode switch electronically upon receipt of a helm command, without requiring any mechanical change to the turbine units.

### F. Cluster Networking and Multi-Layer Redundancy

In multi-unit array deployments, the microcontroller of each turbine unit participates in a bidirectional peer-to-peer mesh network with the microcontrollers of neighboring units, connected to nodes T1, T2, and T3 as shown in FIG. 19. The mesh provides three layers of redundancy. The first layer is automatic load rebalancing on the shared DC bus when a unit enters FAILOVER or MAINTENANCE mode. The second layer is chip-to-chip heartbeat status signaling that triggers automatic load compensation by functional units independent of the DC bus load signal. The third layer is physical power rerouting through the shared electrical interconnect around a failed unit segment. The cluster networking architecture applies across all multi-unit array embodiments: tidal bridge clusters, wind tower arrays, marine hull arrays, and river turbine arrays.

### VIII. River and Canal Turbine Embodiment

### A. Overview

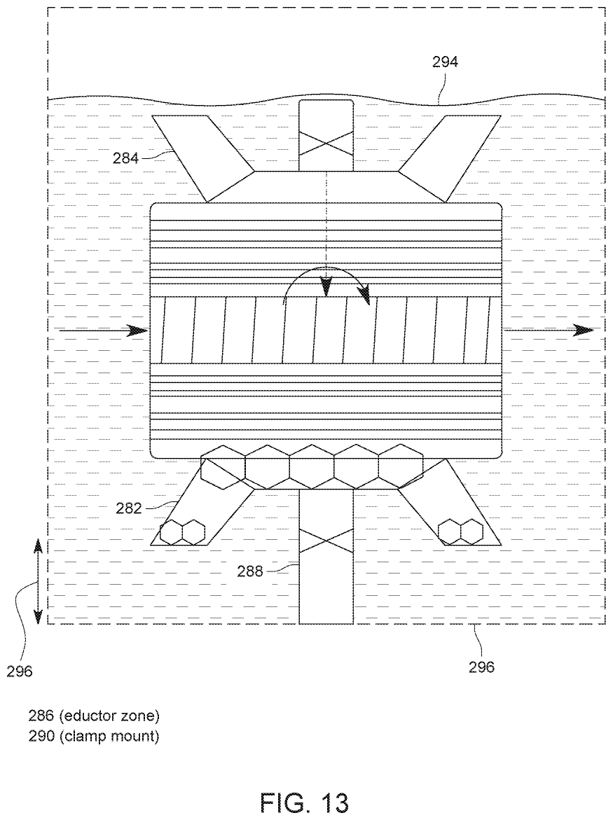

Referring to FIG. 13, the river and canal turbine embodiment employs the same core sealed cylindrical layer architecture as the tidal embodiment, configured for unidirectional river or canal current. The turbine unit is mounted to an existing bridge piling or pier structure via a clamp mount 290 requiring no seabed drilling or new construction permits. The sealed wiring port 128 routes electrical output to the inverter 126 on a structural arm above the waterline 294, above the riverbed 296.

### B. Convergent Inlet Scoop 282

A convergent ram inlet scoop 282 is disposed on the upstream face of the turbine unit, oriented to face the river current, as indicated by flow arrows. A HexWeb CF debris screen 288 is disposed across the mouth of the inlet scoop 282, preventing branches, fish, rocks, sediment, and other debris from reaching the blade tube 110 while permitting water flow through the screen mesh.

### C. Mirrored Exit Scoop 284 and Eductor Effect

A mirrored divergent exit scoop 284 is disposed on the downstream face of the turbine unit. The divergent geometry of the exit scoop 284 creates an eductor zone 286 at the exit of the annular flow channel 130. As the exiting flow expands through the divergent exit scoop 284, its velocity decreases and static pressure recovers below the ambient river pressure at that point, consistent with Bernoulli's principle; this pressure differential at the outlet draws water through the annular flow channel 130 at a velocity exceeding what the ambient river current alone would drive, in the same manner as an ejector or venturi device. This eductor suction effect boosts the velocity of water across the blade tube 110 without any additional energy input beyond the kinetic energy already present in the river current. Since power scales at the cube of velocity, this velocity increase produces substantially more power output versus the same turbine unit without the scoop pair.

In certain embodiments, the river turbine unit employs an alternative dual-exit flow configuration in which the exit manifold splits into two divergent exit streams on opposing sides of the turbine housing rather than a single downstream exit scoop 284, distributing discharge flow to prevent riverbed scour in shallow-water deployments.

### D. Flux Valve River Embodiment

In an alternative river and canal embodiment, the convergent inlet scoop 282 and exit scoop 284 are replaced by bidirectional irising flow gate assemblies 520 and 521 and spiral volute scroll chambers of the type described in Sections II and III, sized for river flow conditions. This embodiment provides storm-mode lockdown capability for rivers subject to seasonal surge or ice events.

### E. Sealed Operation

Water flows through the annular flow channel 130 of the river and canal turbine unit. The motor 116, bearings 112, layer 118, and all inner layers of the turbine unit remain sealed and dry during operation.

### IX. Marine Hull Turbine Array

### A. Configuration

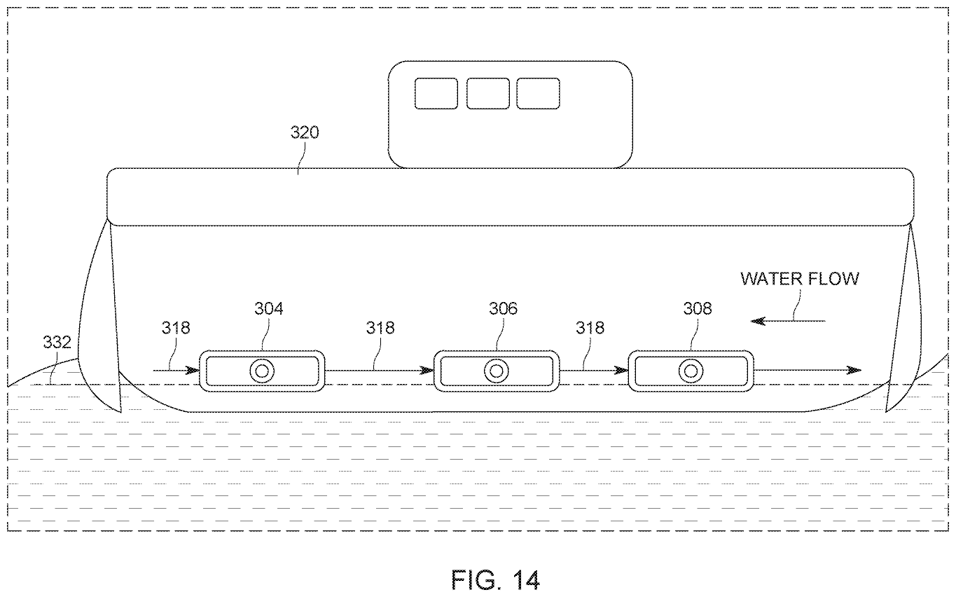

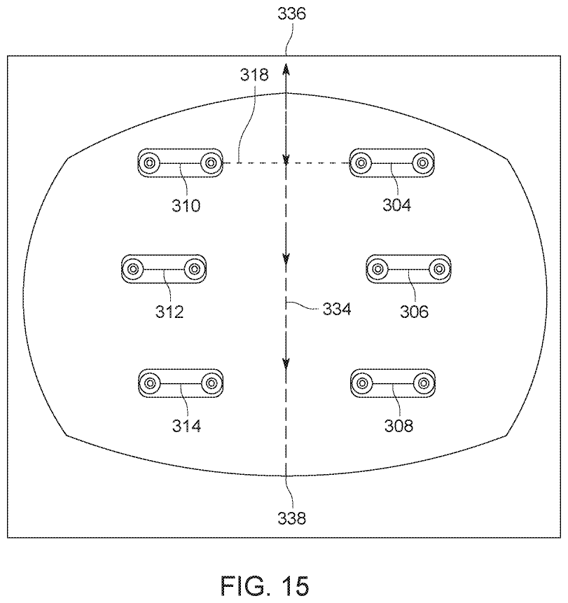

Referring to FIGS. 14 and 15, the marine hull turbine array comprises a plurality of sealed cylindrical turbine units mounted to the hull of a marine vessel below the waterline 332. In one embodiment, six turbine units are mounted in a 3+3 bilateral array configuration: three units on the starboard side comprising a forward starboard unit 304, a midship starboard unit 306, and an aft starboard unit 308; and three units on the port side comprising a forward port unit 310, a midship port unit 312, and an aft port unit 314. The bore axes 318 of each turbine unit are parallel to the vessel centerline, oriented from bow 336 to stern 338. Each unit is mounted flush to the hull via hull flange mounts incorporating an O-ring face seal, with rubber vibration isolation. Tube diameter ranges from approximately 400 to 800 millimeters. The keel 334 is shown in FIG. 15. The tube array along the hull sides provides roll stabilization benefit.

### B. Generator Mode

In generator mode, forward vessel motion creates relative water flow through the annular flow channels 130 of the hull-mounted turbine units in the direction from bow 336 to stern 338. This flow rotates the blade tube 110 and drives the motor 116 as a generator, producing electricity routed through sealed wiring conduits inside the hull to the central power bus 320.

### C. Thruster Mode

In thruster mode, the motor 116 is powered electrically from the ship power bus 320 and drives the blade tube 110 as a pump. Water is drawn in through the stern-facing end of each tube and ejected from the bow-facing end, generating a reaction force that propels the vessel forward. Thruster mode provides low-speed propulsion capability suitable for docking, maneuvering, and emergency propulsion without requiring a separate dedicated thruster system.

### D. Electronic Mode Switching and Contra-Rotation

The control layer 118 controls mode selection for each turbine unit independently or collectively. Mode switching is electronic, requiring no mechanical change to the turbine units. Mode switching is controlled from the vessel helm. Adjacent port and starboard tube pairs are configured to rotate in opposite directions—contra-rotation—canceling net rotational torque imparted to the hull during both generator and thruster operation.

### X. Additional Deployment Embodiments

### A. Pipe Inline Turbine

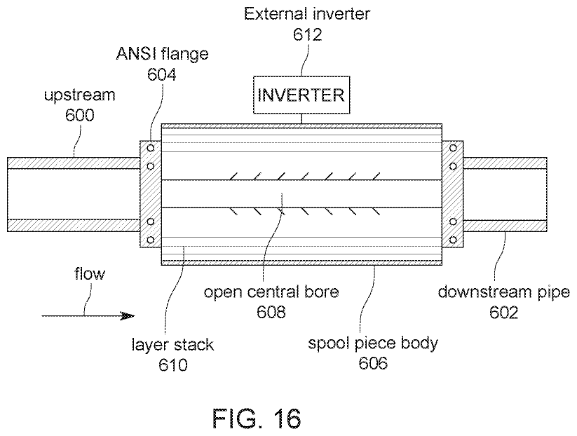

Referring to FIG. 16, the pipe inline turbine embodiment comprises a sealed cylindrical turbine unit configured as a spool piece body 606 installed between an upstream pipe 600 and a downstream pipe 602 of an existing fluid conveyance system. American National Standards Institute (ANSI) flanges 604 on each axial end of the spool piece body 606 are configured for attachment to the upstream pipe 600 and the downstream pipe 602 using compatible pipe flange bolt patterns requiring no welding or specialized installation tools. An open central bore 608 passes axially through the spool piece body 606, through which existing pipe flow is directed to drive the blade tube 110. The layer stack 610 comprises layers L1 and L3 through L7 disposed concentrically around the open central bore 608 within the spool piece body 606, with no inner rubber vibration isolation layers, as the open central bore 608 serves the function of the flow channel. An external inverter 612 is mounted to the exterior of the spool piece body 606. Existing pipe flow pressure drives fluid through the annular flow channel 130, rotating the blade tube 110 and generating electricity without a dedicated pump. The motor 116 and all inner electronics remain hermetically sealed and dry during operation.

### B. Vehicle Turbine

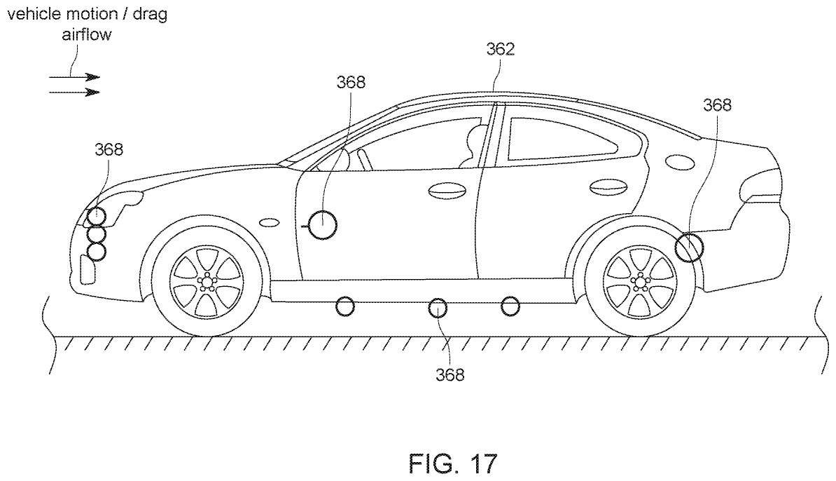

Referring to FIG. 17, the vehicle turbine embodiment comprises a distributed array of scaled-down sealed cylindrical turbine units at multiple exterior vehicle airflow locations on a vehicle body 362. A first group of turbine units 368 is positioned at front grille intake locations of the vehicle body 362, oriented to receive airflow from vehicle forward motion. A second turbine unit 368 is positioned at a side body air intake location. A third group of turbine units 368 is positioned at underbody airflow locations along the underside of the vehicle body 362. A fourth turbine unit 368 is positioned at a wheel-well airflow location. No turbine unit is positioned in the cabin air supply or heating, ventilation, and air conditioning (HVAC) pathway. The turbine housing of each unit is sealed against the vehicle air path with no mechanical connection to the vehicle drivetrain and no exposed rotating parts in the cabin airstream. In certain embodiments, electricity generated is directed to a separate solid-state energy storage module positioned in the vehicle chassis as an independent unit.

### C. Aircraft Nacelle Turbine

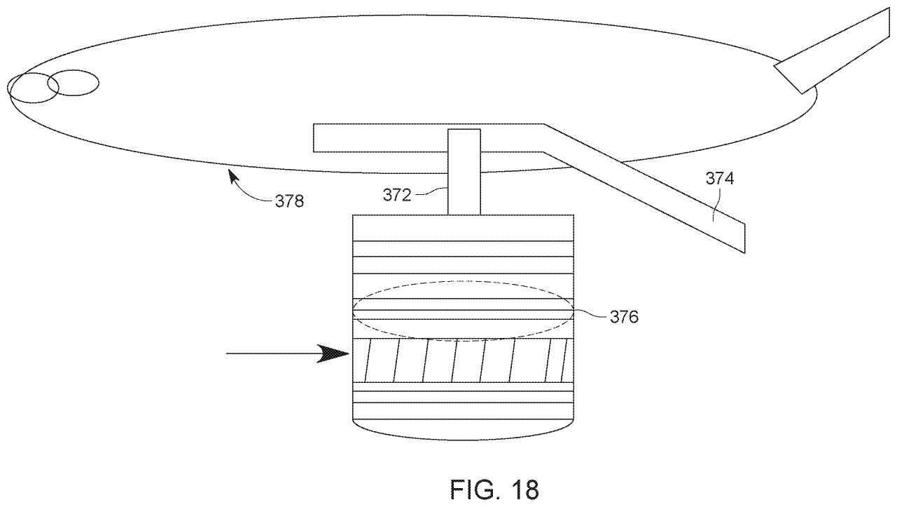

Referring to FIG. 18, the aircraft nacelle turbine embodiment comprises one or more sealed cylindrical turbine units configured as primary propulsion units mounted at nacelle positions on wing pylon hardpoints 372 of the wing 374. In thrust mode, the motor 116 is powered electrically and drives the blade tube 110 as a fan to generate propulsive thrust at the nacelle position, providing primary aircraft propulsion. No fossil fuel engine occupies the nacelle position in this embodiment. A FOD grate 376 comprising HexWeb CF mesh covers the complete inlet face of each turbine unit, protecting against foreign object debris ingestion including ice crystals, runway debris, and bird strike. The turbine housing is hermetically sealed. Electrical energy for thrust mode operation is supplied from an avionics energy storage module 378 positioned in a dedicated bay isolated from the turbine units.

In a regenerative descent configuration, the same turbine unit transitions from thrust mode to generator mode during approach and descent. Airflow acting on the blade tube 110 during descent drives the motor 116 as a generator, recovering kinetic energy from the airstream and charging the avionics energy storage module 378. Mode switching between thrust and generator modes is electronic, requiring no mechanical change to the turbine unit, and is executed upon receipt of a flight management system command.

### E. Additional Embodiments

The present disclosure further contemplates additional embodiments incorporating related improvements. These include, without limitation, a swept delta blade embodiment having a triangular planform with leading-edge sweep; a six-valve radial flux valve alternative embodiment; transmission tower wind array configurations; and micro-turbine implementations scaled for demonstration and low-power applications. These embodiments are supported by the structural principles and platform architecture described herein and may be the subject of claims in this or related applications.

### F. Solid-State Battery Module

The solid-state battery module, as shown in FIG. 21, is a standalone energy storage product configured for pairing with the turbine system via the shared DC bus. The module comprises a plurality of quartz crystal cells, each cell comprising a quartz crystal substrate serving as the solid electrolyte medium, a first electrode plate on a first face of the quartz crystal substrate, and a second electrode plate on an opposing second face of the quartz crystal substrate. The cells are electrically connected in a series-parallel configuration by a bus bar assembly. A battery management system is operatively coupled to the cell array and configured to monitor individual cell voltage, current, and temperature and to protect the cell array against overcharge, over-discharge, and thermal excursion. The solid-state battery module contains no lithium and no flammable organic electrolyte, eliminating thermal runaway risk associated with conventional lithium-ion chemistries. Referring to FIG. 21, the solid-state battery module comprises an outer module housing 620 enclosing a cell array. Each cell comprises a quartz crystal substrate 622 serving as the solid electrolyte medium, a first electrode plate 624 on a first face of the quartz crystal substrate 622, and a second electrode plate 626 on an opposing second face of the quartz crystal substrate 622. The cells are electrically connected in a series-parallel configuration by a bus bar assembly 628 terminating at positive and negative output terminals. The module is dimensioned as an independent unit for installation in a chassis bay, equipment bay, or structural enclosure of the platform to which the turbine system is mounted and is electrically isolated from the turbine housing.

### G. Saltwater Pressure Battery Module

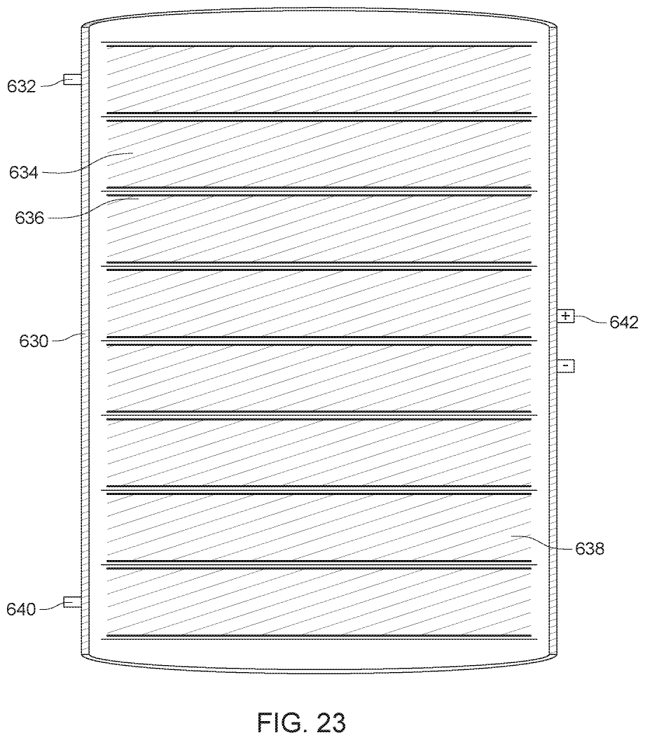

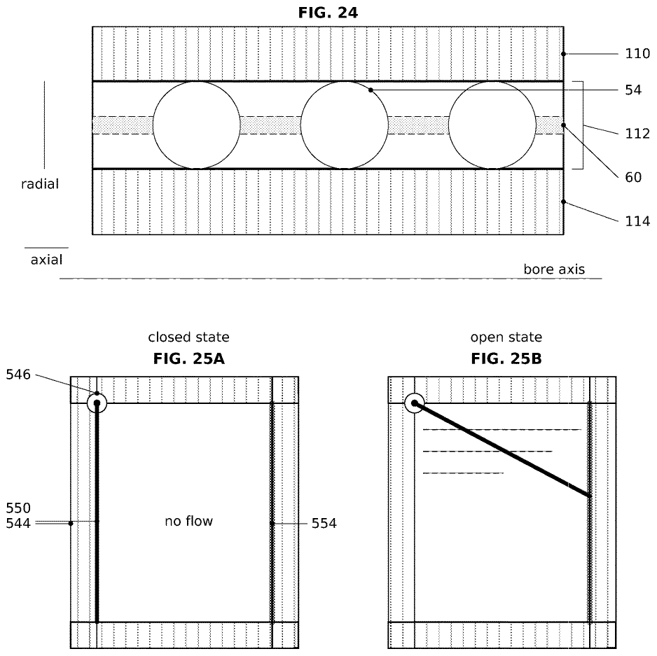

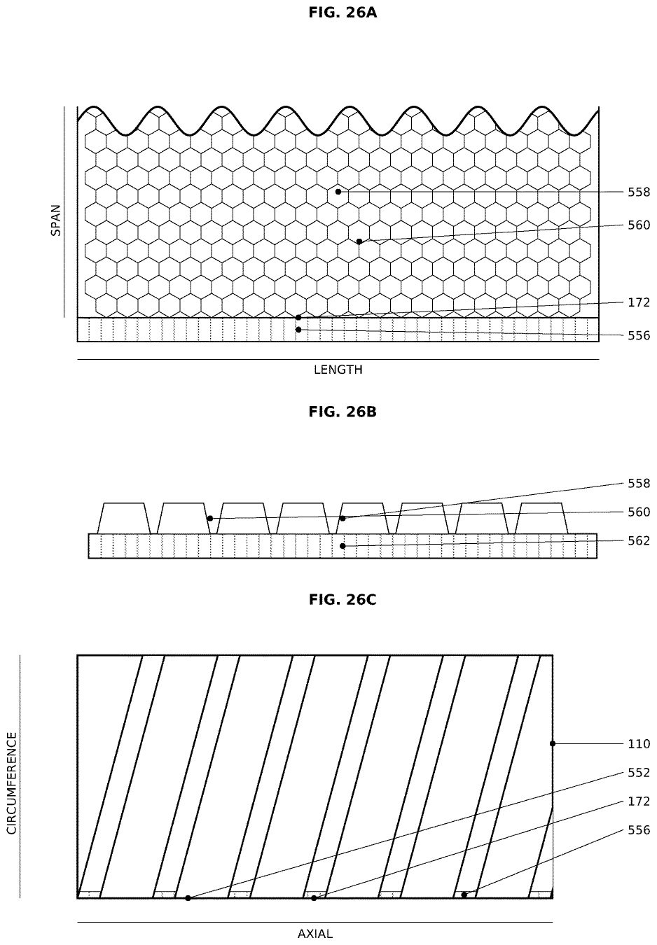

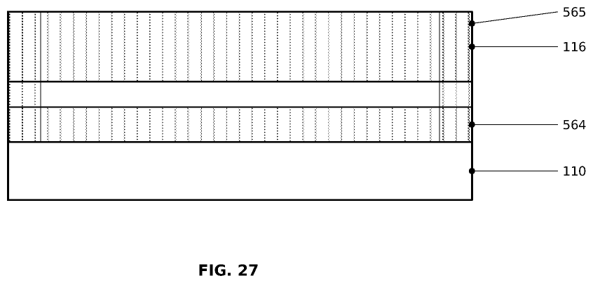

The saltwater pressure battery module, seen in FIG. 23, is a standalone energy storage product configured for pairing with the turbine system via the shared DC bus in marine and tidal deployment environments. The module comprises a sealed marine-grade pressure housing enclosing a cell stack comprising a plurality of anode plates and cathode plates arranged in alternating layers. A saltwater electrolyte comprising an aqueous saline solution occupies the interstitial volume between the anode and cathode plates within the sealed housing. The pressure housing is configured to maintain structural integrity under sustained submersion at the operating depth of the deployment platform. The saltwater pressure battery module contains no lithium, no organic solvent, and no pressurized gas. Referring to FIG. 23, the saltwater pressure battery module comprises a sealed pressure housing 630 having a first end cap 632 and a second end cap 640. A cell stack is disposed within the pressure housing 630 comprising a plurality of anode plates 634 and cathode plates 636 arranged in alternating layers. A saltwater electrolyte occupies the interstitial volume between the anode plates 634 and cathode plates 636 within the pressure housing wall 638. Positive and negative electrical terminals 642 are disposed on the pressure housing wall 638 for connection to the shared DC bus. The module is configured as an independent unit electrically connected to the turbine system via the shared DC bus, and the use of an aqueous saline electrolyte renders the module compatible with the saltwater environment of tidal and marine deployments without requiring a separately sealed liquid electrolyte reservoir.

It should be understood, of course, that the foregoing relates to embodiments of the present disclosure and that modifications may be made without departing from the spirit and scope of the invention as set forth in the following claims.

What is claimed is:

1. A turbine apparatus for generating electrical energy from a fluid flow, comprising: a sealed cylindrical housing having a longitudinal axis, the sealed cylindrical housing comprising a plurality of concentrically arranged layers including at least a rotating blade tube carrying a blade ring on an inner cylindrical face thereof, the blade ring having a plurality of blades extending radially inward toward the longitudinal axis, and a motor layer comprising a rotor incorporating high-strength permanent magnets and a stator configured to convert rotational energy into electrical energy, the motor layer operatively coupled to the blade tube, the blade tube being the sole rotating layer of the sealed cylindrical housing; and a mounting interface configured to attach the sealed cylindrical housing to a pre-existing support structure without modification of the pre-existing support structure.

2. The turbine apparatus of claim 1, further comprising a dedicated thermal management and control layer that is a discrete structural layer positioned between the motor layer and an outermost layer of the sealed cylindrical housing, the dedicated thermal management and control layer comprising a microcontroller, a rotational speed sensor, a temperature sensor, a vibration sensor, a flow velocity sensor, a flux valve pressure sensor, a heating element, a cooling element, a blade-pitch actuator output configured to drive a blade-pitch actuator that sets a pitch angle of variable-pitch blades carried by the blade tube, and a wireless telemetry module, the dedicated thermal management and control layer being separate from the motor layer and maintaining operational performance across a temperature range of −40° F. to +200° F.

3. The turbine apparatus of claim 1, further comprising a bearing layer disposed between the blade tube and the motor layer, the bearing layer comprising CNT-ceramic hybrid bearing elements enabling low-friction rotational movement of the blade tube relative to the motor layer.

4. The turbine apparatus of claim 1, wherein each of the plurality of blades comprises a blade strip having a straight root edge bonded to the inner cylindrical face of the blade ring and a second longitudinal edge, the second longitudinal edge being one of (a) a non-planar distal edge extending radially inward toward the longitudinal axis and (b) a further edge bonded to the inner cylindrical face of the blade ring such that adjacent blade strips define bounded flow passages.

5. The turbine apparatus of claim 4, wherein each blade strip follows a helical path along the inner cylindrical face of the blade ring from a first axial end of the blade tube to a second axial end of the blade tube, the straight root edge of each blade strip being bonded to the inner cylindrical face along the full length of the helical path wherein each blade strip presents blade surface area at multiple axial positions along the bore simultaneously.

6. The turbine apparatus of claim 1, further comprising: a spiral channel disposed at each of a first fluid inlet and a second fluid inlet of the sealed cylindrical housing, each spiral channel having an entry throat and a blade inlet zone, the spiral channel decreasing in cross-sectional area from the entry throat to the blade inlet zone such that fluid entering the entry throat is accelerated and angularly pre-rotated about the longitudinal axis in a direction of rotation of the blade tube prior to contact with the plurality of blades, the spiral channel at the first fluid inlet and the spiral channel at the second fluid inlet being mirror images of each other such that fluid entering from either fluid inlet is angularly accelerated in the same direction of rotation of the blade tube; and a flow gate assembly disposed at the first fluid inlet and at the second fluid inlet, each flow gate assembly selectively permitting or blocking fluid entry into its respective spiral volute scroll in response to fluid pressure differential and operable in: a first state wherein the first fluid inlet is open and the second fluid inlet is closed, fluid entering through the first fluid inlet being angularly pre-rotated before contacting the plurality of blades, the blade tube rotating in a first rotational direction; a second state wherein the second fluid inlet is open and the first fluid inlet is closed, fluid entering through the second fluid inlet being angularly pre-rotated before contacting the plurality of blades, the blade tube continuing to rotate in the first rotational direction; and a third state wherein both the first fluid inlet and the second fluid inlet are simultaneously closed, the sealed cylindrical housing being fully sealed against fluid ingress; wherein transition between the first state and the second state is actuated by fluid pressure differential without active motor or sensor control.

7. The turbine apparatus of claim 6, wherein the first fluid inlet and the second fluid inlet are disposed at opposing axial ends of the sealed cylindrical housing as annular end cap assemblies, each annular end cap assembly comprising a spiral volute scroll having a tangential entry throat, a cutwater, a sealing collar configured to maintain a watertight static seal against a central support structure passing through the sealed cylindrical housing, and a piling bore through which the central support structure passes, wherein the central support structure is a pre-existing infrastructure element to which the mounting interface attaches the sealed cylindrical housing.

8. The turbine apparatus of claim 6, wherein the third state is triggered by a microcontroller upon detection of a fluid pressure differential exceeding a predetermined threshold indicative of storm surge or abnormal flow conditions, the microcontroller actively driving both the first valve and the second valve to a closed position, and wherein the bidirectional flow gate assembly automatically returns to the first state or the second state upon the microcontroller detecting return of the fluid pressure differential to below the predetermined threshold, without requiring manual intervention.

9. The turbine apparatus of claim 4, wherein each blade strip is mounted on a pivot pin at the straight root edge, and the blade strip is rotated on the pivot pin from a first pitch position to a mirrored second pitch position by one of (a) a passive cam mechanism mechanically linked to an actuation motion of a bidirectional flow gate assembly of the sealed cylindrical housing and (b) a blade-pitch actuator driven by a microcontroller, the first pitch position presenting a predetermined blade angle of attack for fluid flow from a first fluid inlet and the mirrored second pitch position presenting a predetermined blade angle of attack for fluid flow from a second fluid inlet.

10. The turbine apparatus of claim 1, wherein the pre-existing support structure is a submerged infrastructure structure in a tidal or river environment, wherein the mounting interface secures the sealed cylindrical housing to the submerged infrastructure structure without drilling into, anchoring to, or otherwise modifying a seabed or riverbed, and wherein the sealed cylindrical housing maintains operational integrity under continuous saltwater submersion.

11. The turbine apparatus of claim 1, wherein the sealed cylindrical housing is structured and dimensioned for installation within an existing fluid conveyance pipe, the sealed cylindrical housing comprising an open central bore through which fluid from the existing fluid conveyance pipe flows to drive the plurality of blades, and fluid-tight end connections configured for attachment to the existing fluid conveyance pipe, and wherein no layer inward of the blade tube contacts fluid flowing through the existing fluid conveyance pipe.

12. An infrastructure-integrated turbine apparatus comprising: a sealed tubular turbine unit having a longitudinal bore axis and comprising a plurality of concentrically arranged sealed layers, a blade assembly comprising a blade ring carrying a plurality of blades on an inner cylindrical face thereof and defining an annular flow channel between the inner cylindrical face and a central bore of the sealed tubular turbine unit, the blade ring configured to rotate about the longitudinal bore axis when fluid flows through the annular flow channel, the plurality of blades extending radially inward from the inner cylindrical face toward the longitudinal bore axis, and an electromagnetic generator assembly comprising a permanent magnet array mounted to the blade ring and a stator winding mounted to a fixed layer of the plurality of concentrically arranged sealed layers; and a clamping mounting interface configured to attach the sealed tubular turbine unit to a pre-existing structural member forming part of existing infrastructure, wherein the clamping mounting interface does not require drilling, anchoring to a seabed or riverbed, or any other modification of the pre-existing structural member.

13. The infrastructure-integrated turbine apparatus of claim 12, wherein the sealed tubular turbine unit is configured as a toroidal ring comprising a first ring and a second ring, the first ring mounted on a passive omnidirectional swivel joint configured to permit rotation of the first ring about a first axis in response to wind pressure acting on the first ring without active motor or sensor control, the second ring configured to rotate about a second axis independent of the first axis in response to wind contacting the plurality of blades, and wherein the center of the toroidal ring defines an open central bore permitting unobstructed passage therethrough.

14. The infrastructure-integrated turbine apparatus of claim 12, wherein the sealed tubular turbine unit further comprises a convergent inlet scoop disposed on an upstream face of the sealed tubular turbine unit configured to direct river or canal current into the annular flow channel, and a divergent exit structure disposed on a downstream face of the sealed tubular turbine unit configured to create a low-pressure zone at an exit of the annular flow channel that draws fluid through the annular flow channel at a velocity exceeding ambient current velocity.

15. The infrastructure-integrated turbine apparatus of claim 12, wherein the sealed tubular turbine unit is mounted to a hull of a marine vessel below a waterline of the marine vessel with the longitudinal bore axis oriented to receive flow from vessel motion through water, the sealed tubular turbine unit operable in a generator mode wherein relative water flow from vessel motion drives fluid through the annular flow channel to generate electrical energy.

16. The infrastructure-integrated turbine apparatus of claim 15, wherein the sealed tubular turbine unit is further operable in a thruster mode wherein the electromagnetic generator assembly is powered as a motor to drive the blade ring as a pump generating propulsive thrust, with electronic mode switching between the generator mode and the thruster mode.

17. The infrastructure-integrated turbine apparatus of claim 12, further comprising a plurality of additional sealed tubular turbine units each secured to the pre-existing structural member or to a structure connected thereto by a respective clamping mounting interface, each turbine unit independently operable, a shared electrical output bus electrically connecting the turbine units to a shared inverter or energy storage device, and a bidirectional peer-to-peer mesh communication network interconnecting a dedicated thermal management and control layer within each of the turbine units, the mesh communication network configured to broadcast operating mode status among units, automatically rebalance electrical load on the shared electrical output bus upon a unit entering a reduced-output or offline mode, and reroute electrical power through the shared electrical output bus around a failed unit segment.

18. A method of generating electrical current from fluid flow, comprising: attaching a sealed cylindrical turbine housing to a pre-existing infrastructure structure using a clamping mounting interface that does not modify the pre-existing infrastructure structure; directing fluid flow through an annular flow channel of the sealed cylindrical turbine housing to drive a rotating blade tube carrying a blade ring on an inner cylindrical face thereof, the blade ring having a plurality of blades extending radially inward toward a longitudinal axis of the sealed cylindrical turbine housing; rotating a permanent magnet array mounted to the blade ring relative to a stationary stator winding to generate the electrical current; and transmitting the electrical current through an inverter to an electrical grid or energy storage device.

19. The method of claim 18, wherein directing fluid flow through the annular flow channel comprises impinging the fluid upon a plurality of blade strips arranged along the inner cylindrical face of the blade ring, each blade strip having a straight root edge bonded to the inner cylindrical face and a non-planar distal edge facing the annular flow channel, each blade strip following a helical path along the inner cylindrical face from a first axial end of the blade tube to a second axial end of the blade tube such that fluid engages a surface of each blade strip at multiple axial positions simultaneously.

20. The method of claim 18, further comprising: during a first tidal phase, opening a first fluid inlet of the sealed cylindrical turbine housing and closing a second fluid inlet, fluid entering through the first fluid inlet being angularly pre-rotated by a first spiral channel before contacting the blade ring, the blade tube rotating in a first rotational direction; during a second tidal phase, closing the first fluid inlet and opening the second fluid inlet, fluid entering through the second fluid inlet being angularly pre-rotated by a second spiral channel before contacting the blade ring, the blade tube continuing to rotate in the first rotational direction, the first spiral channel and the second spiral channel being mirror images of each other such that fluid entering from either fluid inlet is angularly pre-rotated in the first rotational direction, transition between phases being actuated by fluid pressure differential without active motor or sensor control; and upon detection by a microcontroller of a dedicated control layer of the sealed cylindrical turbine housing of a fluid pressure differential exceeding a predetermined storm surge threshold, actively driving both the first fluid inlet and the second fluid inlet to a closed position to fully seal the sealed cylindrical turbine housing against fluid ingress, and automatically reopening whichever of the first fluid inlet and the second fluid inlet corresponds to a then-prevailing direction of fluid flow upon detection of return of the fluid pressure differential to below the predetermined storm surge threshold.
